(19) United States
(12) Patent Application Publication
(10) Pub. No.: US 2015/0045454 A1
(43) Pub. Date: Feb. 12, 2015

(54) METHODS AND COMPOSITIONS RELATING TO STARCH FIBERS

(71) Applicant: The Penn State Research Foundation, University Park, PA (US)

(72) Inventors: Lingyan Kong, State College, PA (US); Gregory R. Ziegler, State College, PA (US)

(73) Assignee: THE PENN STATE RESEARCH FOUNDATION, University Park, PA (US)

(21) Appl. No.: 14/381,121

(22) PCT Filed: Feb. 27, 2013
(86) PCT No.: PCT/US13/27993

§ 371 Date: Aug. 26, 2014

Related U.S. Application Data
(60) Provisional application No. 61/603,580, filed on Feb. 27, 2012.

(51) Int. Cl. D01F 9/00; D01D 5/00; C08L 3/02

(52) U.S. Cl. CPC D01F 9/00; C08L 3/02; D01D 5/0046
USPC 514/778; 106/206.1; 106/217.3; 106/163.01; 106/217.01; 435/183; 426/650; 426/661; 264/465

(57) ABSTRACT

Methods are provided according to aspects of the present invention for making starch fiber or particle compositions by wet-electrospinning or wet-electrospraying including providing a solution or dispersion of starch in an aqueous or non-aqueous solvent or dispersant, where the starch is present at a concentration above the critical entanglement concentration, with the proviso that the aqueous or non-aqueous solvent or dispersant does not consist only of water; heating the solution or dispersion of starch to a temperature above the crystallization temperature of the starch; electro spinning or electro spraying the heated solution or dispersion of starch to produce starch fibers or starch particles, respectively; and contacting the starch fibers or starch particles with a coagulation bath fluid.

### REFERENCE TO RELATED APPLICATION

This application claims priority from U.S. Provisional Patent Application Ser. No. 61/603,580, filed Feb. 27, 2012, the entire content of which is incorporated herein by reference.

### GOVERNMENT SUPPORT

This invention was made with government support under Hatch Act Project No. PEN04194 awarded by the United States Department of Agriculture. The Government has certain rights in the invention.

### FIELD OF THE INVENTION

Generally described, the present invention relates to starch fiber and particle compositions and methods of making starch fiber and starch particle compositions. More specifically, the present invention relates to wet-electrospinning and electro spray methods for producing starch fiber and starch particle compositions.

### BACKGROUND OF THE INVENTION

Fibers and articles incorporating fibers are ubiquitous in modern life. However, pervasive use of non-natural materials has environmental consequences. Fibers and particles formed from biological materials where the primary component is starch are provided by the present invention.

### SUMMARY OF THE INVENTION

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; and contacting the starch fibers or starch particles with a coagulation bath fluid, forming a starch fiber composition or starch particle composition.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; and washing the starch fiber composition or starch particle composition in a wash fluid to at least partially remove the solvent or dispersant.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; washing the starch fiber composition or starch particle composition in a wash fluid to at least partially remove the solvent or dispersant; and heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; and heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol.

According to aspects of the present invention, the starch fiber composition or starch particle composition is dried after production, after washing, after heating or after cross-linking.

According to aspects of the invention, the solution or dispersion of starch is mixed with one or more of: a filler, a non-starch polymer, a plasticizer and an auxiliary material. Two or more types of starch can be included in the solution or dispersion of starch. Auxiliary materials include, without limitation, bioactive compounds, drugs, pharmaceutical compositions; food ingredients, flavoring agents, dyes, enzymes; agricultural agents, pesticides, industrial agents, deodorants, corrosion inhibitors, fluorescent dyes, catalysts; and combinations of any two or more thereof.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; and exposing the starch fiber composition or starch particle composition to a cross-linking agent to produce a cross-linked starch fiber composition or cross-linked starch particle composition.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; washing the starch fiber composition or starch particle composition in a wash fluid to at least partially remove the solvent or dispersant; and exposing the starch fiber composition or starch particle composition to a cross-linking agent to produce a cross-linked starch fiber composition or cross-linked starch particle composition.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; washing the starch fiber composition or starch particle composition in a wash fluid to at least partially remove the solvent or dispersant; heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol; and exposing the starch fiber composition or starch particle composition to a cross-linking agent to produce a cross-linked starch fiber composition or cross-linked starch particle composition.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; contacting the starch fibers or starch particles with a coagulation bath fluid, forming a starch fiber composition or starch particle composition; heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol; and exposing the starch fiber composition or starch particle composition to a cross-linking agent to produce a cross-linked starch fiber composition or cross-linked starch particle composition.

An aqueous or non-aqueous solvent or dispersant used is selected from: DMSO, an aqueous solution of DMSO, aqueous solution of N-methyl morpholine N-oxide (NMMO), N,N-dimethylacetamide with 3% LiCl, dimethylformamide (DMF), and an aqueous solution of DMF; with the proviso that the aqueous or non-aqueous solvent or dispersant does not consist only of water.

According to aspects of the present invention, the coagulation bath fluid is an alcohol or an alcohol/water mixture having an alcohol/water ratio in the range of 20/80-99.9/0.1.

According to aspects of the present invention, the coagulation bath fluid is an alcohol or an alcohol/water mixture having an alcohol/water ratio in the range of 20/80-99.9/0.1, wherein the alcohol is selected from the group consisting of: methanol, ethanol, 1-propanol, isopropyl alcohol, butyl alcohol, amyl alcohol, pentanol, hexanol, heptanol; and a mixture of any two or more thereof.

According to aspects of the present invention, heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol includes heating the starch fiber composition or starch particle composition in an aqueous or non-aqueous solution of alcohol wherein the aqueous or non-aqueous solution of alcohol is an alcohol or an alcohol/water mixture having an alcohol/water ratio in the range of 20/80-100/0, and wherein the alcohol is selected from the group consisting of: methanol, ethanol, 1-propanol, isopropyl alcohol, butyl alcohol, amyl alcohol, pentanol, hexanol, heptanol; and a mixture of any two or more thereof.

Methods for making a starch fiber composition or starch particle composition are provided according to aspects of the present invention which include providing a spinning dope comprising a solution or dispersion of starch in an aqueous or non-aqueous solvent or dispersant and an auxiliary material, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; and contacting the starch fibers or starch particles with a coagulation bath fluid, forming a starch fiber composition or starch particle composition including the auxiliary material.

Methods for making a starch fiber composition or starch particle composition are provided according to aspects of the present invention which include providing a spinning dope comprising a solution or dispersion of starch in an aqueous or non-aqueous solvent or dispersant and an auxiliary material selected from the group consisting of: a bioactive compound, a drug, a pharmaceutical, a food ingredient, a flavoring agent, a dye, an enzyme, an agricultural agent, a pesticide, an industrial agent, a deodorant, a corrosion inhibitor, a fluorescent dye a catalyst or two or more thereof, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; and contacting the starch fibers or starch particles with a coagulation bath fluid, forming a starch fiber composition or starch particle composition including the auxiliary material.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; and contacting the starch fibers or starch particles with a coagulation bath fluid, the coagulation bath fluid including an auxiliary material, forming a starch fiber composition or starch particle composition including the auxiliary material.

Methods for making a starch fiber composition or starch particle composition are provided according to aspects of the present invention which include providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water; heating the spinning dope to a temperature above the melting temperature or dissolution temperature of starch in the solvent or dispersant to produce a heated spinning dope; wet-electrospinning or wet-electrospraying the heated spinning dope to produce starch fibers or starch particles, respectively; and contacting the starch fibers or starch particles with a coagulation bath fluid, the coagulation bath fluid including an auxiliary material selected from the group consisting of: a bioactive compound, a drug, a pharmaceutical, a food ingredient, a flavoring agent, a dye, an enzyme, an agricultural agent, a pesticide, an industrial agent, a deodorant, a corrosion inhibitor, a fluorescent dye a catalyst or two or more thereof, forming a starch fiber composition or starch particle composition including the auxiliary material.

Starch fiber compositions and starch particle compositions are provided according to aspects of the present invention which include at least 50, 60, 70, 80, 90, 95, 99 or greater wt % starch and a nanoparticulate filler. Starch fiber compositions and starch particle compositions are provided according to aspects of the present invention which include at least 50, 60, 70, 80, 90, 95, 99 or greater wt % starch, a nanoparticulate filler and an auxiliary material. The starch fibers and starch particles have a diameter in the range of 1-999 nanometers according to aspects of the present invention. The starch fibers and starch particles have a diameter in the range of 1-999 micrometers according to aspects of the present invention.

Starch fiber compositions and starch particle compositions are provided according to aspects of the present invention which include at least 50, 60, 70, 80, 90, 95, 99 or greater wt % starch and a nanoparticulate filler, wherein the starch is cross-linked.

A nanoparticulate filler included in starch fiber compositions and starch particle compositions provided according to aspects of the present invention are clay nanoparticles.

A nanoparticulate filler included in starch fiber compositions and starch particle compositions provided according to aspects of the present invention are cellulose nanoparticles.

A nanoparticulate filler included in starch fiber compositions and starch particle compositions provided according to aspects of the present invention are cellulose nanowhiskers.

A nanoparticulate filler included in starch fiber compositions and starch particle compositions provided according to aspects of the present invention are carbon nanoparticles.

Starch fiber compositions and starch particle compositions are provided according to aspects of the present invention which include at least 50, 60, 70, 80, 90, 95, 99 or greater wt % starch, a nanoparticulate filler and an auxiliary material selected from the group consisting of: a bioactive compound, a drug, a pharmaceutical, a food ingredient, a flavoring agent, a dye, an enzyme, an agricultural agent, a pesticide, an industrial agent, a deodorant, a corrosion inhibitor, a fluorescent dye a catalyst or two or more thereof.

### BRIEF DESCRIPTION OF THE DRAWINGS

FIG. 1 is a diagram of a “wet-electrospinning” apparatus;

FIG. 2 shows X-ray diffraction patterns of (i) modified clay, (ii) as-spun electrospun starch/clay fibers and (iii) electrospun starch/clay fibers after post-spinning heat treatment;

FIG. 3 shows X-ray diffraction patterns of (i) microcrystalline cellulose, (ii) as-spun electrospun starch/microcrystalline cellulose fibers and (iii) electrospun starch/microcrystalline cellulose fibers after post-spinning heat treatment;

FIG. 4 is a graph showing diameters of starch fibers produced in Example 1;

FIG. 5 shows thermograms of wet-electrospun starch fibers heated in various ethanol/water mixtures (v/v): (i) 0/100, (ii) 20/80, (iii) 40/60, (iv) 50/50, (v) 60/40, (vi) 80/20, and (vii) 100/0;

FIG. 6 shows thermograms of wet-electrospun starch fibers (i) heated in 50% (v/v) ethanol and (ii) scanned in 50% (v/v) ethanol after being held at 65° C. for 30 minutes;

FIG. 7 shows X-ray diffraction patterns of (i) as-spun wet-electrospun starch fibers and (ii) wet-electrospun starch fibers after post-spinning heat treatment

FIG. 8 shows flow curves of Gelose 80 starch in 100% DMSO as a function of starch concentration (% w/v) at 20° C.;

FIG. 9 shows a plot of specific viscosity versus Gelose 80 starch concentration in 100% DMSO;

FIG. 10 shows plots of specific viscosity versus Gelose 80 starch concentration in (a) 97.5%, (b) 95%, (c) 92.5%, (d) 90%, (e) 85%, (f) 80%, (g) 75%, and (h) 70% (v/v) DMSO aqueous solutions;

FIG. 11 shows a graph of the entanglement concentrations of Gelose 80 starch as a function of DMSO concentration;

FIG. 12 shows the results of evaluation of fiber formation abilities from starch dispersions of different starch and DMSO concentrations;

FIG. 13 shows shear viscosities (at 100 s⁻¹) of the Gelose 80 starch dispersions plotted as a function of starch concentration in different DMSO concentrations;

FIGS. 14 a-e show plots of specific viscosity versus starch concentration for (a) Hylon VII (HVII), (b) Hylon V (HV), (c) Mung bean starch (MB), (d) Melojel starch (MJ), and (e) Amioca waxy maize starch (AM) in 95% (v/v) DMSO aqueous solution;

FIG. 14f shows a plot of entanglement concentration as a function of amylose content in the starches;

FIG. 15 shows results of evaluation of wet-electrospinnability from starch dispersions of different starches in 95% DMSO;

FIG. 16 shows X-ray diffraction patterns of (A) starch without guest, (B) starch-PA, and (C) starch-AP fibers from coagulation baths containing (i) 100% and (ii) 75% (v/v) ethanol, respectively;

FIG. 17 shows FTIR spectra of starch-PA fibers from coagulation baths containing (A) 100% (v/v) and (B) 75% (v/v) ethanol, with different PA levels in spinning dope: (i) 1%, (ii) 2.5%, and (iii) 5% (w/w) of starch;

FIG. 18 shows FTIR spectra of starch-AP fibers from coagulation baths containing (A) 100% (v/v) and (B) 75% (v/v) ethanol, with different AP levels in spinning dope: (i) 1%, and (ii) 5% (w/w) of starch;

FIG. 19 shows DSC curves of starch-PA fibers from coagulation baths containing (A) 100% (v/v) and (B) 75% (v/v) ethanol, with different PA levels in spinning dope: (i) 1%, (ii) 2.5%, and (iii) 5% (w/w) of starch;

FIG. 20 shows DSC curves of starch-AP fibers from coagulation baths containing (A) 100% (v/v) and (B) 75% (v/v) ethanol, with different AP levels in spinning dope: (i) 1%, and (ii) 5% (w/w) of starch;

FIG. 21 shows X-ray diffraction patterns of starch fibers from coagulation baths containing (A) 0.5% (w/v) AP and (B) 2% (w/v) CTAB in (i) 100% and (ii) 75% (v/v) ethanol, respectively;

FIG. 22 shows FTIR spectra of starch fibers from coagulation baths containing (A) 100% (v/v) and (B) 75% (v/v) ethanol and different AP concentrations: (i) 0.1%, and (ii) 0.5% (v/v) of the coagulation bath;

FIG. 23 shows DSC curves of starch fibers from coagulation baths containing (A) 100% (v/v) and (B) 75% (v/v) ethanol and different AP concentrations: (i) 0.1%, and (ii) 0.5% (w/v) of the coagulation bath;

FIG. 24 shows DSC curves of starch fibers from coagulation baths containing (A) 100% (v/v) and (B) 75% (v/v) ethanol and different CTAB concentrations: (i) 0.1%, (ii) 1%, and (iii) 2% (w/v) of the coagulation bath;

FIG. 25 shows X-ray diffraction patterns of lipid-free starch fibers recovered from coagulation bath containing (i) 100% and (ii) 75% (v/v) ethanol;

FIG. 26 shows DSC curves of (i) lipid-free starch fibers and (ii) lipid-free starch-AP (5%, w/w) fibers from 75% (v/v) ethanol;

FIG. 27 shows FTIR spectra of lipid-free starch-AP (5%, w/w) fibers recovered from (i) 100% and (ii) 75% (v/v) ethanol;

FIG. 28 shows X-ray diffraction patterns of wet-electrosprayed powders from coagulation baths containing (i) 100% and (ii) 75% (v/v) ethanol, respectively; and

FIG. 29 shows DSC curves of wet-electrosprayed powders from coagulation baths containing (A) 100% and (B) 75% (v/v) ethanol, respectively.

### DETAILED DESCRIPTION OF THE INVENTION

Starch fiber compositions, starch particle compositions and methods of making starch fiber and starch particle compositions are provided according to the present invention.

Starch fiber compositions and starch particle compositions according to the present invention have utility in various applications including, but not limited to, wound dressings, drug delivery/release, filtration, sensor applications, and in other areas of the food, electronics, cosmetics, textile, and medical and biomedical industries.

The term “fiber” as used herein refers to an elongated structure which has a length at least 100 times its width or diameter. Microfibers and nanofibers are produced by methods of the present invention having micro- and/or nanoscale dimensions of length and width or diameter. A cross section of a fiber may have any shape but is typically a circle or oval. The term “particle” as used herein refers to a structure which has a length less than 100 times its width or diameter. Microparticles and nanoparticles are produced by methods of the present invention having micro- and/or nanoscale dimensions of length and width or diameter. A cross section of a particle may have any shape, including irregular, but is typically a circle or oval.

Methods are provided according to aspects of the present invention for making starch fiber compositions by wet-electrospinning including providing a solution or dispersion of starch in an aqueous or non-aqueous solvent or dispersant, that is, a spinning dope, where the starch is present at a concentration above the critical entanglement concentration, with the proviso that the aqueous or non-aqueous solvent or dispersant does not consist only of water; heating the solution or dispersion of starch to a temperature above the melting temperature or dissolution temperature of starch in the solvent or dispersant to produce a heated solution or dispersion of starch; wet-electrospinning the heated solution or dispersion of starch to produce starch fibers; and contacting the starch fibers with a coagulation bath fluid, forming a starch fiber composition.

The term “heated solution or dispersion of starch” refers to a solution or dispersion of starch that has been heated to a temperature above the melting temperature or dissolution temperature of starch in the solvent or dispersant where the heated solution or dispersion of starch, i.e. the heated spinning dope, is to be subjected to wet-electrospinning for production of starch fibers. The term “heated solution or dispersion of starch” refers to a solution or dispersion of starch that has been heated to a temperature above the crystallization temperature of starch in the solvent or dispersant where the solution dispersion of starch, i.e. the heated spinning dope, is to be subjected to wet-electrospraying for production of starch particles. The heated solution or dispersion of starch, i.e. the heated spinning dope may be maintained at a temperature above the melting temperature or dissolution temperature of starch in the solvent or dispersant during wet-electrospinning or may be cooled or allowed to cool to a temperature below the melting temperature or dissolution temperature of starch in the solvent or dispersant for wet-electrospinning. The heated solution or dispersion of starch, i.e. the heated spinning dope may be maintained at a temperature above the crystallization temperature of starch in the solvent or dispersant during wet-electrospraying or at a temperature below the crystallization temperature.

Methods are provided according to aspects of the present invention for making starch particle compositions by wet-electrospraying including providing a solution or dispersion of starch in an aqueous or non-aqueous solvent or dispersant, that is, a spinning dope, where the starch is present at a concentration of 1-40% w/w, with the proviso that the aqueous or non-aqueous solvent or dispersant does not consist only of water; heating the spinning dope to a temperature above the crystallization temperature of the starch to produce a heated spinning dope; wet-electrospraying the heated solution or dispersion of starch, i.e. the spinning dope, to produce starch particles; and contacting the starch particles with a coagulation bath fluid, forming a starch particle composition.

A temperature above the melting temperature or dissolution temperature of starch is in the range of 50-160° C. and methods according to aspects of the present invention include heating the solution or dispersion of starch to a temperature in the range of 50-160° C. to produce a heated solution or dispersion of starch. Methods according to aspects of the present invention include heating the solution or dispersion of starch to a temperature in the range of 70-140° C. to produce a heated solution or dispersion of starch. Methods according to aspects of the present invention include heating the solution or dispersion of starch to a temperature in the range of 80-100° C. to produce a heated solution or dispersion of starch.

Starch is among the most abundant and inexpensive biopolymers. Starch is found in plant tissues, such as leaves, stems, seeds, roots and tubers. It is also found in certain algae and bacteria. Starch exists in semi-crystalline granules of different size, shape and morphology depending on its botanical source. Nevertheless, most starches are composed of two structurally distinct molecules: amylose, a linear or lightly branched (1→4)-linked α-glucopyranose, and amylopectin, a highly branched molecule of (1→4)-linked α-glucopyranose with α-(1→6) branch linkages. The amylose/amylopectin ratio in starches varies with botanical origin.

Starches included in methods and starch fiber compositions according to aspects of the present invention can be any naturally occurring starch, synthetic and/or physically or chemically modified starch. The amylose content of the starches included in methods and starch fiber compositions according to aspects of the present invention ranges from 25%-100%. Non-limiting examples of included starches are mung bean starch, corn starch with amylose content of about 50% such as corn starch available commercially as Gelose 50, unmodified high amylose corn starch which contains approximately 55% amylose such as corn starch available commercially as Hylon V, unmodified high amylose corn starch which contains approximately 70% amylose such as corn starch available commercially as Hylon VII and corn starch with amylose content of about 80% available such as corn starch available commercially as Gelose 80.

A sufficient amount of starch is dissolved or dispersed in an aqueous or non-aqueous solvent or dispersant so that the starch concentration is above its critical entanglement concentration (cₑ). To determine the critical entanglement concentration, specific viscosity data were plotted versus concentration on a log-log plot. Specific viscosity is ηₛₚ=(η₀−ηₛ)/ηnₛ, where η₀ is zero shear rate viscosity and ηₛ is the solvent viscosity. The zero shear rate viscosity can be estimated, using the actual or extrapolated values for apparent viscosity at 0.1 s⁻¹, for example. The critical entanglement concentration cₑ is defined as the concentration at which a slope change is observed at the crossover between the semidilute unentangled regime and the semidilute entangled regime of a polymer solution. In the semidilute unentangled regime, polymer chains overlap one another but do not entangle, whereas in the semidilute entangled regime, polymer chains significantly overlap one another such that individual chain motion is constrained.

Methods are provided according to aspects of the present invention for making starch fiber compositions and starch particle compositions including providing a spinning dope including a solution or dispersion of starch in an aqueous or non-aqueous solvent or dispersant, and optionally including one or more non-starch components. Optional non-starch components included in the spinning dope illustratively include one or more non-starch polymers, one or more fillers, one or more plasticizers or a combination of any two or more thereof. In a further option, the spinning dope excludes ionic liquids.

Methods are provided according to aspects of the present invention for making starch fiber compositions and starch particle compositions including providing a spinning dope including a solution or dispersion of two or more starches in an aqueous or non-aqueous solvent or dispersant, and optionally including one or more non-starch components. The two or more starches can be naturally occurring starches, synthetic starches, and/or physically or chemically modified starches of various amylose content, including, but not limited to, starch acetate, starch phosphates, starch succinates, hydroxypropylated starches, dextrin roasted starches, acid treated starches, alkaline treated starches, oxidized starches, bleached starches, enzyme-treated starches, examples of which include, but are not limited to acetylated distarch adipate, acetylated oxidized starch, monostarch phosphate, distarch phosphate, phosphated distarch phosphate, acetylated distarch phosphate, hydroxypropyl starch, hydroxypropyl distarch phosphate and starch sodium octenylsuccinate.

The term “spinning dope” as used herein refers to a material subjected to wet-electrospinning or wet-electrospraying according to methods of the present invention.

Advantageously, no non-starch high polymer, plasticizer or emulsifier is required to be included in the spinning dope or produced fibers or particles.

The spinning dope used in methods according to aspects of the present invention includes at least 50, 55, 60, 65, 70, 75, 80, 85, 90, 91, 92, 93, 94, 95, 96, 97, 98, 99 or greater wt % starch in the dissolved or dispersed solid component of the spinning dope. According to aspects of the present invention, the spinning dope includes a ratio of starch to the total of all other solid materials in the spinning dope in the range of 50/50-99.9/0.1 w/w. According to aspects of the present invention, the spinning dope includes starch as the only solid, to produce pure starch fibers.

According to aspects of the present invention, starch fiber compositions include a ratio of starch to non-starch high polymers in the range of 50/50-99.9/0.1 w/w. According to aspects of the present invention, starch fiber compositions include a ratio of starch to the total of all other materials in the composition in the range of 50/50-99.9/0.1 w/w. Fibers and particles produced by methods according to aspects of the present invention include at least 50, 55, 60, 65, 70, 75, 80, 85, 90, 91, 92, 93, 94, 95, 96, 97, 98, 99 or greater wt % starch.

According to aspects of the present invention, starch fiber compositions exclude non-starch high polymers, plasticizers and/or emulsifiers.

An aqueous or non-aqueous solvent or dispersant included in the spinning dope and used in methods according to aspects of the present invention allows for dissolution or dispersion of the starch and promotes sufficient chain entanglements. Pure water is found to be a non-useful solvent since fiber formation is unsuccessful when water alone is used to dissolve or disperse starch according to aspects of the present invention. Thus, an aqueous or non-aqueous solvent or dispersant used in methods according to aspects of the present invention is not 100% water. Without wishing to be bound by theory, such failure might be explained by the conformation of two components of starch in aqueous solution. Moderate heating below 100° C., while able to gelatinize the starch and form a homogeneous dispersion, may not completely disrupt starch helices, and these helices may cause rapid recrystallization upon cooling. Sufficient long-range chain entanglements for continuous fiber formation, cannot be established without untwisting helices into random coils. Furthermore, the highly-branched structure of amylopectin gives it a globular bulky hydrodynamic shape, which is not easily elongated and aligned in the extensional flow field of the spinneret.

According to aspects of the present invention the aqueous or non-aqueous solvent or dispersant included in the spinning dope is selected from: DMSO, an aqueous solution of DMSO, aqueous solution of N-methyl morpholine N-oxide (NMMO), N,N-dimethylacetamide with 3% LiCl, dimethylformamide (DMF), and an aqueous solution of DMF.

According to aspects of the present invention the aqueous or non-aqueous solvent or dispersant included in the spinning dope is selected from: DMSO and an aqueous solution of DMSO having a DMSO/water ratio in the range of 60/40-99.9/0.1.

A “wet-electrospinning” apparatus used in methods according to aspects of the present invention includes a reservoir for the spinning dope with a spinneret, a grounded collector and a high voltage power supply. In methods according to aspects of the present invention, the spinning dope is fed into a reservoir and maintained at a temperature above or below its melting temperature or dissolution temperature of starch in the solvent or dispersant. When the spinning dope is pumped through the spinneret, a high voltage, typically in the range of 50 to 500 kV/m, is applied between the spinning dope and a grounded collector in the coagulation bath. With increasing voltage the electrostatic force deforms the droplet into a pointed shape. Further increase in voltage induces a jet from the needle. The starch fibers formed are deposited in contact with the coagulation bath.

The coagulation bath fluid used is one capable of extracting the aqueous or non-aqueous solvent or dispersant in the spinning dope from the starch fibers and/or starch particles and precipitating the starch polymer.

According to aspects of the present invention the coagulation bath is an alcohol or an alcohol/water mixture having an alcohol/water ratio in the range of 20/80-99.9/0.1.

The term “alcohol” as used herein refers to C1-C7 alcohols and includes, without limitation, methanol, ethanol, 1-propanol, isopropyl alcohol, butyl alcohol, amyl alcohol, pentanol, hexanol, heptanol; and mixtures of any two or more thereof.

According to aspects of the present invention, the coagulation bath includes methanol, ethanol, 1-propanol, isopropyl alcohol, butyl alcohol, amyl alcohol, pentanol, hexanol, heptanol; or a mixture of any two or more thereof. According to aspects of the present invention, a liquid that is miscible with DMSO but incompatible with starch can be used as a coagulation bath.

Optionally, the coagulation bath excludes ammonium sulfates. In a further option, the coagulation bath excludes salts.

Optionally, the coagulation bath consists of methanol, ethanol, 1-propanol, isopropyl alcohol, butyl alcohol, amyl alcohol, pentanol, hexanol, heptanol; or a mixture of any two or more thereof.

According to aspects of the present invention, methods for making starch fiber compositions further include washing the starch fiber composition or starch particle composition in a wash fluid to at least partially remove the aqueous or non-aqueous solvent or dispersant which was present in the spinning dope. According to aspects of the present invention the wash fluid is an alcohol or an alcohol/water mixture having an alcohol/water ratio in the range of 50/50-99.9/0.1. According to aspects of the present invention, the wash fluid includes methanol, ethanol, 1-propanol, isopropyl alcohol, butyl alcohol, amyl alcohol, pentanol, hexanol, heptanol; or a mixture of any two or more thereof.

According to aspects of the present invention, methods for making starch fiber compositions and starch particle compositions further include heating the starch fiber compositions and/or starch particle compositions in alcohol or an aqueous or non-aqueous solution of alcohol at a temperature below the melting temperature or dissolution temperature of the starch fiber composition or starch particle composition in the aqueous or non-aqueous solution of alcohol. A post-spinning heat treatment increases the crystallinity of the starch fibers and/or particles, improving mechanical properties and water resistance. In a non-limiting example, the starch fibers are heated in an alcohol/water mixture, for example 50/50 volume ratio, at a temperature between the crystallization temperature and the melting temperature of the starch fibers or starch particles, e.g. 65 degrees Centigrade.

The “crystallization temperature” is the lowest onset temperature of an exotherm when heating starch in the solvent or dispersant at any heating rate.

According to aspects of the present invention, methods are for making starch fiber compositions and starch particle compositions further include drying the starch fiber composition.

According to aspects of the present invention, methods for making starch fiber compositions and starch particle compositions further include mixing a filler with the solution or dispersion of starch to produce the spinning dope used in wet-electrospinning or wet-electrospraying, respectively. The filler is substantially insoluble in the aqueous or non-aqueous solvent or dispersant included in the spinning dope. As used herein, the term “substantially insoluble” when referring to an included filler indicates that less than 5 parts of the filler, more preferably less than 2 parts of the filler, would dissolve in 100 parts of the coagulation bath fluid at room temperature. According to aspects of the present invention, a spinning dope includes 0.01 to 10 wt % filler by weight of the starch. According to aspects of the present invention, the filler includes nanoparticles, such as but not limited to clay, nanoparticulate cellulose and/or carbon nanoparticles such as but not limited to carbon nanotubes.

According to aspects of the present invention, methods for making starch fiber or starch particle compositions include mixing a nano-structured clay filler with the solution or dispersion of starch to produce a spinning dope. According to aspects of the present invention, a spinning dope includes 0.01 to 10 wt % of one or more nano-structured clay fillers by weight of the starch. Nano-structured clay fillers illustratively include layered double hydroxides and montmorillonite layered silicates.

According to aspects of the present invention, methods are for making starch fiber or starch particle compositions further include exposing the starch fiber or starch particle composition to a cross-linking agent to produce a cross-linked starch fiber or starch particle composition. Starch cross-linkers include but are not limited to polyamide-epichlorohydrin resin, glyoxylated polyacrylamide resin, urea formaldehyde, melamine formaldehyde, polyethylenimine type resin, glyoxal, glutaraldehyde and genipin.

According to aspects of the present invention, methods are for making starch fiber or starch particle compositions include both a post-spinning heat treatment to increase the crystallinity of the starch fibers and/or particles including heating the starch fiber compositions and/or starch particle compositions in alcohol or an aqueous or non-aqueous solution of alcohol at a temperature below the melting temperature or dissolution temperature of the starch fiber composition or starch particle composition in the aqueous or non-aqueous solution of alcohol and exposing the starch fiber or starch particle composition to a cross-linking agent to produce a cross-linked starch fiber or starch particle composition. The post-spinning heat treatment may be performed before or after the cross-linking.

According to aspects of the present invention, methods for making starch fiber and starch particle compositions further include adding one or more plasticizers to the spinning dope.

A plasticizer included in the spinning dope is miscible with starch and is substantially insoluble in the coagulation bath fluid. As used herein, the term “substantially insoluble” when referring to an included plasticizer indicates that less than 5 parts of the plasticizer, more preferably less than 2 parts of the plasticizer, would dissolve in 100 parts of the coagulation bath fluid at room temperature.

A plasticizer may be excluded from the spinning dope, and starch fibers/particles of the present invention. Optionally, a plasticizer is present in the spinning dope and starch fibers/particles in amounts up to 100% w/w of starch. In other words, starch and one or more plasticizers are present in a starch:plasticizer ratio in the range of 1:0.01-1:1 w/w in the spinning dope and starch fibers/particles of the present invention.

The spinning dope used in methods according to aspects of the present invention to make starch fibers or particles has a total solid content in the range of about 5%-50% w/v, more preferably 10%-30% w/v.

Starch fibers and starch particles produced by methods according to aspects of the present invention have a total starch content in the range of about 5%-100% w/w, more preferably 10%-100% w/w of total solid content.

Optionally, the coagulation bath fluid includes one or more plasticizers to inhibit extraction of one or more plasticizers from the solution or dispersion of starch. Preferably, the one or more plasticizers in the coagulation bath are present at a higher concentration than saturation concentration of the one or more plasticizers in the coagulation bath to inhibit extraction. Optionally, the coagulation bath is saturated or supersaturated with the plasticizer or plasticizers included in the spinning dope.

Preferred plasticizers are polyhydric alcohols having at least 5 carbons. An included polyhydric alcohol can have a linear carbon backbone, or be branched or cyclic. Non-limiting examples of included polyhydric alcohols having at least 5 carbons are pentoses, hexoses, saccharides, including monosaccharides, disaccharides, trisaccharides or higher polysaccharides, including any isoforms and stereoisomers thereof. Non-limiting examples of included polyhydric alcohols having at least 5 carbons are sorbitol, xylitol, mannitol, maltitol, trehalose and lactitol.

According to aspects of the present invention, methods for making starch fiber and starch particle compositions further include adding one or more modified starches and/or one or more non-starch polymers.

A modified starch may be excluded from the spinning dope, and starch fibers/particles of the present invention. Optionally, a modified starch is present in the spinning dope and starch fibers/particles in amounts up to 100% w/w of starch. In other words, starch and one or more modified starches are present in a starch:modified starch ratio in the range of 1:0.01-1:1 w/w in the spinning dope and starch fibers/particles of the present invention.

Any modified starch compatible with starch and any other materials included in compositions and in methods of the present invention may be used.

A substance is “compatible” with starch if it mixes with a starch solution without phase separation for a period of time sufficient to prepare a spinning dope and perform wet-electrospinning or wet-electrospraying according to methods of the present invention as described herein.

Non-limiting examples of modified starch included in methods and compositions according to aspects of the present invention include starch acetate.

A non-starch polymer may be excluded from the spinning dope, and starch fibers/particles of the present invention. Optionally, a non-starch polymer is present in the spinning dope and starch fibers/particles in amounts up to 100% w/w of starch. In other words, starch and one or more non-starch polymers are present in a starch:non-starch polymer ratio in the range of 1:0.01-1:1 w/w in the spinning dope and starch fibers/particles of the present invention.

Any non-starch polymer compatible with starch and any other materials included in compositions and in methods of the present invention may be used. According to aspects of the present invention an included non-starch polymer is an uncharged biodegradable non-starch polymer.

The term “biodegradable non-starch polymer” as used herein refers to a polymer which degrades by the action of environmental factors such as heat, moisture, air and biological activity, such as microbial action and/or in vivo metabolic activity. A biodegradable non-starch polymer is degraded by the action of such environmental factors to smaller components of the polymer, such as oligomers, monomer subunits or smaller molecular non-subunit components.

Non-limiting examples of uncharged biodegradable non-starch polymers included in methods and compositions according to aspects of the present invention include pullulan, alpha-cyclodextrin, beta-cyclodextrin, dextran, agarose, cellulose, methylcellulose, hydroxypropyl methyl cellulose, gelatin, poly(ethylene oxide) and mixtures of any two or more thereof.

According to aspects of the present invention, methods for making starch fiber and starch particle compositions further include adding an auxiliary material, mixed with or bound to the starch fibers and starch particles, including but not limited to bioactive compounds, drugs, pharmaceuticals; food ingredients such as flavors, dyes and enzymes; agricultural agents such as pesticides; and industrial agents such as deodorants, corrosion inhibitors, fluorescent dyes and catalysts.

An auxiliary material is incorporated in starch fiber and starch particle compositions according to aspects of methods of the present invention by inclusion in the spinning dope and/or in the coagulation bath.

Starch fiber compositions and starch particle compositions are provided according to aspects of the present invention. The inventive starch fiber compositions include micron- and/or nano-scale fibers characterized by high surface-to-volume ratio, high porosity, small pore size according to aspects of the present invention.

Starch fiber compositions provided according to aspects of the present invention include at least 50, 60, 70, 80, 90, 95, 99 or greater wt % starch and a filler, such as a nanoparticulate filler. Cross-linked starch fiber compositions are provided according to aspects of the present invention.

Embodiments of inventive compositions and methods are illustrated in the following examples. These examples are provided for illustrative purposes and are not considered limitations on the scope of inventive compositions and methods.

### EXAMPLES

### Example 1

Gelose 80 used in this example, is a corn starch with amylose content of about 80% commercially obtained from Penford Food Ingredients Company, Centennial, Colo., USA. A modified layered double hydroxide (LDH) anionic clay was used as a filler in some examples described herein. The LDH of the formula [Mg_{4.5}Al₂(OH)₁₃](CO₃).3.5H₂O is commercially available from Sechang Co. Ltd. (Jeonbuk, Korea) and was modified to have benzoate anion intercalated as described in detail in Costantino et al., ACS Applied Materials & Interfaces, 1(3):668-677, 2009. Microcrystalline cellulose (Avicel FD 100) was obtained from FMC Biopolymers (Philadelphia, Pa.).

Starch Fibers

Spinning dope was prepared by dissolving starch (15% w/w) in a 95% aqueous DMSO solution. The starch dispersion was heated in a boiling water bath with continuous stirring for about one hour, and allowed to cool to room temperature. This spinning dope was then subjected to wet-electrospinning as described below.

Wet-Electro Spinning

A 10 mL syringe (Becton, Dickinson and Company, Franklin Lakes, N.J.) with a 20-gauge blunt needle was used for wet-electrospinning.

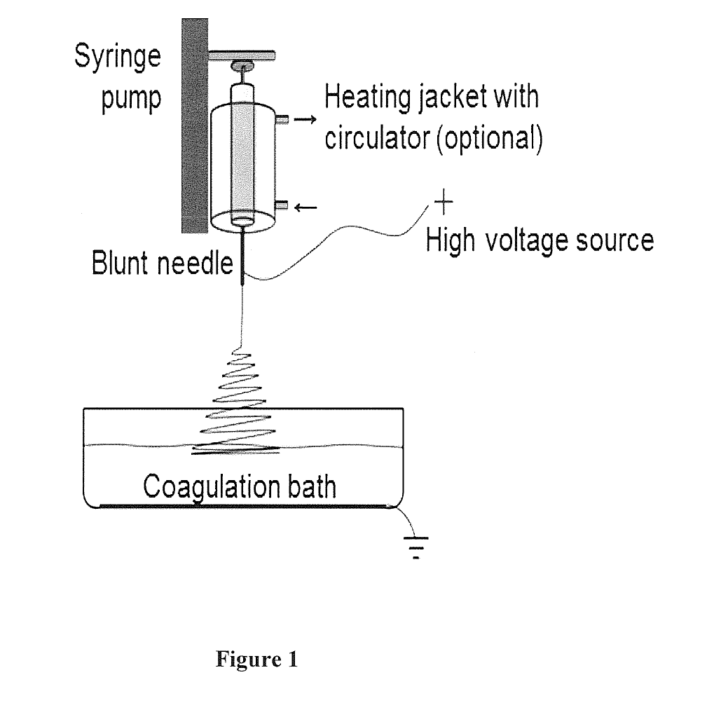

The “wet-electrospinning” apparatus used contained a high voltage power supply (ES40P, Gamma High Voltage Research, Inc., Ormond Beach, Fla.), a syringe pump (81620, Hamilton Company, Reno, Nev.), and a grounded metal mesh immersed in a coagulation bath of 100% ethanol, shown diagrammatically in FIG. 1. This configuration is also termed “electro-wet-spinning.” The distance of the needle tip to the liquid surface of the coagulation bath was kept at 7.5 cm. The dope was extruded through the needle and a voltage of 10kV was supplied. The fibrous mat deposited on the surface of the coagulation bath was washed with ethanol and dried in a desiccator containing Drierite under vacuum.

Starch/Filler Composite Fibers

Starch/clay and starch/cellulose dispersions in 95% DMSO were subject to wet-electrospinning as described above. Clay (1% w/w starch) or cellulose (10% w/w starch) was dispersed in 95% DMSO with ultrasonic assistance. Fifteen wt % high amylose corn starch (Hylon VII) was then dissolved in the dispersion and the dispersion heated in boiling water bath with continuous stirring for about one hour. The dispersions were then allowed to cool to room temperature and electrospun into pure ethanol as the coagulation bath as described for pure starch fibers herein.

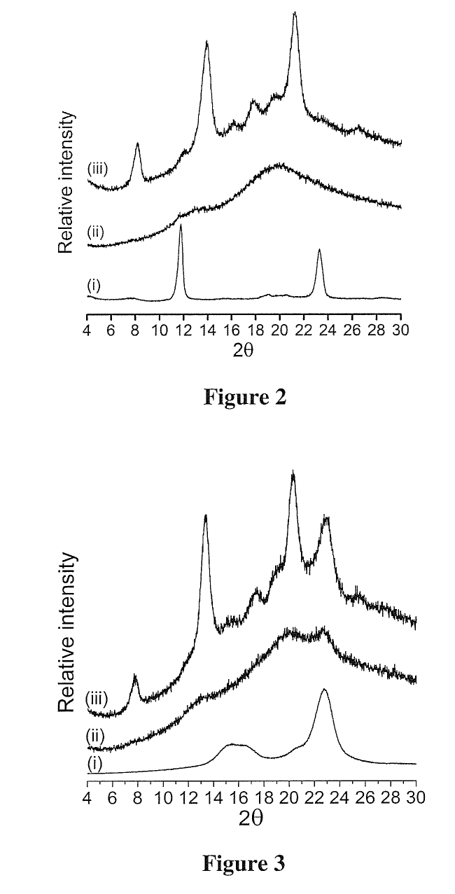

Scanning electron microscopy and wide-angle X-ray diffraction were used to characterize electrospun starch/clay composite fibers and starch/cellulose composite fibers. The fiber surface was smooth. XRD indicated the presence of clay in the starch/clay fiber, but without significant exfoliation as evidenced by the peak at 11.8° as shown in FIGS. 2 and 3. FIG. 2 shows X-ray diffraction patterns of (i) modified clay, (ii) as-spun electrospun starch/clay fibers and (iii) electrospun starch/clay fibers after post-spinning heat treatment. FIG. 3 shows X-ray diffraction patterns of (i) microcrystalline cellulose, (ii) as-spun electrospun starch/microcrystalline cellulose fibers and (iii) electrospun starch/microcrystalline cellulose fibers after post-spinning heat treatment.

Morphological Characterization

Morphology of the starch fiber compositions was examined using an Olympus BX41 optical microscope (Hitech Instruments, Edgemont, Pa., USA) equipped with cross polarizers and a SPOT Insight QE camera (SPOT Diagnostic Instruments, Sterling Heights, Mich., USA). Image analysis was completed using SPOT analytical and controlling software. Observation of fibers was also performed using a FEI Quanta 200 ESEM (FEI, Hillsboro, Oreg., USA) in low vacuum mode at an accelerating voltage of 20 keV. Fiber diameter was measured from the ESEM images. Three images were used for each fiber sample and at least 50 different segments were randomly measured to obtain an average diameter.

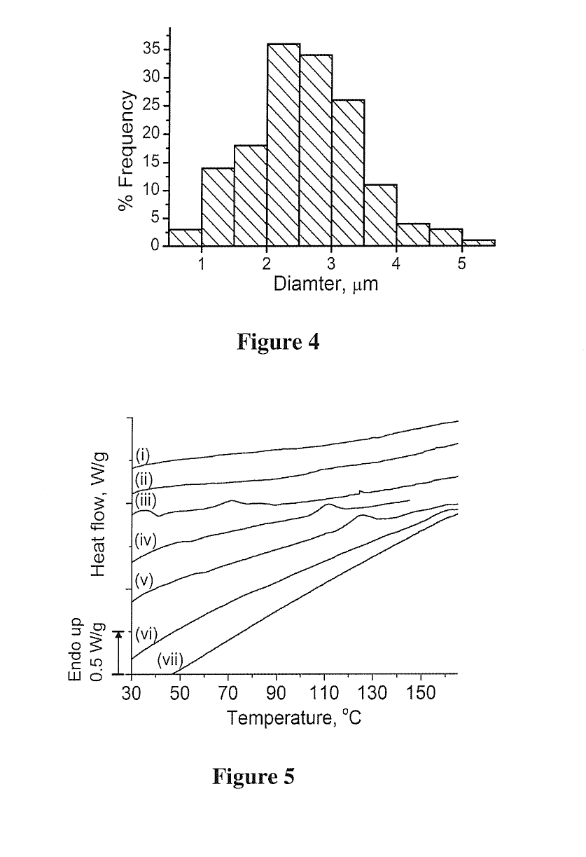

When a voltage was applied between the needle tip and the coagulation bath, starch dispersion dopes were accelerated towards the coagulation bath, and a continuous jet was obtained at a critical voltage. A fiber mat was deposited on the bath surface, the size of which was dependent upon the electric field strength. After drying, the appearance and texture of the starch fiber mat resembled a piece of bath tissue, though not as flexible. The pure starch fibers within the mat were randomly oriented, with an average diameter of 2.60±0.85 μm as shown in the graph of FIG. 4. The fiber surface appeared smooth and the fibers were largely continuous. Some breaks existed, possibly indicating that the starch fibers are relatively brittle, which was confirmed by their behavior on handling. Extensive drying in a desiccator eliminated ethanol as well as moisture, which play a role as plasticizer of the starch fibers. A thin section of the fiber mat was observed under optical microscopy with normal light and between crossed polarizers, respectively. Although the birefringence from thicker sections, may result from multiple refractions by overlaying fibers, the single fibers do show birefringence. The birefringence obtained using crossed polarizers results from orientation of starch chains in the fiber axis direction.

Thermal Analysis

Approximately 2.5 to 3 mg of each starch fiber composition was weighed in a 60 μL stainless steel differential scanning calorimeter (DSC) pan (Perkin-Elmer Instruments, Bridgeville, Pa.) and ethanol/water mixtures of different volume ratios were added to obtain a 5% (w/w) dispersion. Pans were hermetically sealed and stored overnight for moisture equilibration. Samples were equilibrated at 20° C., and then heated to 170° C. at a scanning rate of 2° C./min in a Thermal Advantage Q100 DSC (TA Instruments, New Castle, Del.). The DSC was calibrated with indium and an empty sample pan was used as a reference. Data was analyzed using the TA Universal Analysis software (Universal Analysis 2000 v.4.2E, TA Instruments-Waters LLC, New Castle, Del.).

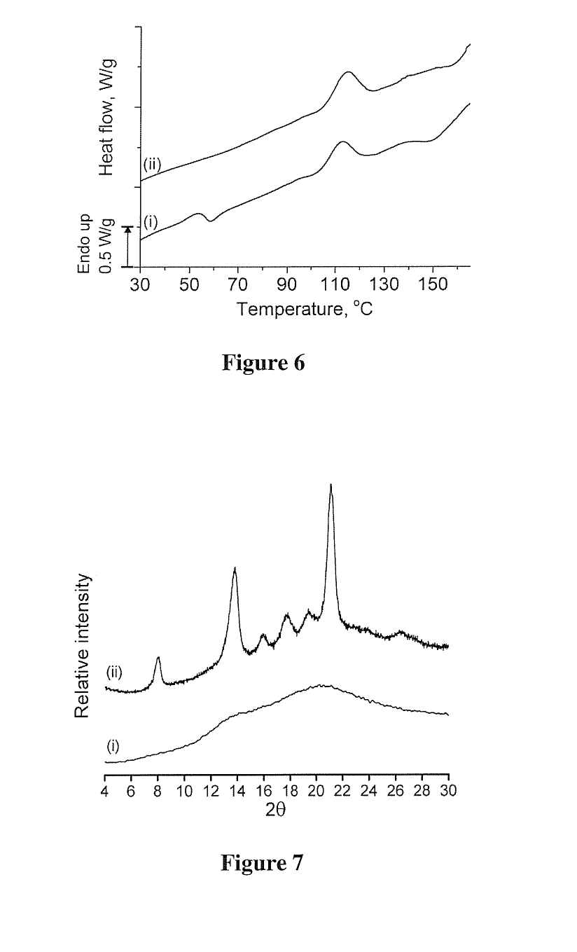

Thermal transitions appeared when starch fibers were heated in solvents of intermediate water:ethanol concentrations as shown in FIGS. 5 and 6 and Table 1.

FIG. 5 shows thermograms of electrospun starch fibers heated in various ethanol/water mixtures (v/v): (i) 0/100, (ii) 20/80, (iii) 40/60, (iv) 50/50, (v) 60/40, (vi) 80/20, and (vii) 100/0.

FIG. 6 shows thermograms of electrospun starch fibers (i) heated in 50% (v/v) ethanol and (ii) scanned in 50% (v/v) ethanol after being held at 65° C. for 30 minutes.

TABLE 1
Thermal analyses of starch fibers in various ethanol/water mixtures.

| Ethanol/water | Exothermic | | | Endothermic | | |
|---|---|---|---|---|---|---|
| (v/v) | Tp (° C.) | Range (° C.) | ΔH (J/g) | Tp (° C.) | Range (° C.) | ΔH (J/g) |
| 0/100 | | | | | | |
| 20/80 | | | | 108.6 | 100.7-130.9 | 4.2 |
| 40/60 | 40.9 | 36.0-47.5 | 3.5 | 71.2 | 61.8-77.5 | 5.2 |
| 50/50 | 54.5 | 48.5-62.1 | 1.1 | 111.2 | 101.2-120.3 | 7.7 |
| 60/40 | 61.4 | 56.1-67.0 | 0.9 | 125.1 | 113.7-136.1 | 11.8 |
| 80/20 | | | | 158.6 | 150.6-164.3 | 2.9 |
| 100/0 | | | | | | |

At aqueous ethanol concentrations between 40 and 60% (v/v), both exothermic and endothermic peaks were observed, likely corresponding to the crystallization of amorphous starch followed by melting. An annealing treatment is applied to increase the crystallinity of the starch fibers. Starch fibers were held at 65° C. for 30 minutes in 50% (v/v) aqueous ethanol. After this heat treatment, the exotherm was seen to disappear and the endotherm increased slightly to 114.4° C. and 14.2 J/g. At higher ethanol concentrations there appeared to be insufficient water for annealing to occur.

Post-Spinning Heat Treatment

The dried starch or starch composite fibers were subjected to heat treatment to increase the starch crystallinity. For the heat treatment, a sample of starch fiber mat was placed in a 50% (v/v) aqueous ethanol solution and heated at 65° C. for one hour, after which the sample was washed with ethanol and dried as above.

Since the fibers were deposited in a random manner, wide-angle X-ray diffraction patterns were obtained from the fiber mat with an X-ray powder diffractometer. FIG. 7 shows X-ray diffraction patterns of (i) as-spun electrospun starch fibers and (ii) electrospun starch fibers after post-spinning heat treatment. As spun, the dried starch fibers were largely amorphous. After annealing, peaks at 8°, 13.8°, 15.9°, 17.7°, 19.4° and 21°, characteristic of a V-type diffraction pattern, were observed. Based on a hexagonal crystal structure proposed for V-type starch, the unit cell dimensions were calculated to be a=b=25.9 Å and c=5.6 Å. The parameters are close to reported values but smaller, indicating that the helices are closely packed in a hexagonal arrangement after extensive drying. The degree of crystallinity of the heat-treated starch fibers was estimated to be 43%. Without wishing to be bound by theory, it appears that amylose helices rearrange and crystallize during the moderate annealing of the fibers in the ethanol/water mixture.

Post-Spinning Cross-Linking Treatment

The dried starch or starch/filler composite fibers were subjected to a cross-linking treatment to increase water stability. For the cross-linking treatment, a sample starch fiber mat on a metal mesh was place over a petri dish in a desiccator with Drierite. Ten (10) mL of 25% (v/v) aqueous glutaraldehyde solution was dispersed evenly in the petri dish. The desiccator was kept in an incubator at 40° C. for 24 hours for the glutaraldehyde to vaporize and cross-link the starch fibers.

Scanning electron microscopy was performed to determine the morphology of the cross-linked pure starch fibers. The appearance and size of the cross-linked pure starch fibers remained unchanged when compared with the pure starch fibers without cross-linking.

Wet Stability

The wet stability of the as-spun starch fibers, heat-treated fibers and vapor phase glutaraldehyde cross-linked fibers were compared. Fiber mats of the same size were dropped into water and observed using optical microscopy. When placed in water, both the as-spun and heat-treated starch fiber mats became soft, and lost integrity when picked up with tweezers. In contrast, the cross-linked starch fiber mat did not disintegrate when placed into water, and can be recovered from the water without losing its fibrous structure. Optical micrographs of these fiber mats after immersion in water for 10 minutes were obtained and analyzed. The as-spun and heat-treated starch fibers lost their fibrous structure after wetting and formed a gel like structure. Even though the heat-treated starch fibers were highly crystalline, a sufficiently large amount of amorphous structure susceptible to plasticization by water apparently remained. The cross-linked starch fibers retained the original fibrous structure. The cross-linking mechanism of glutaraldehyde is a reaction between terminal aldehydes and hydroxyl groups of starch to the formation of acetals. In this way, glutaraldehyde bridges the starch helices into a network, which is difficult to disintegrate in water.

Wide Angle X-Ray Diffraction Analysis

Wide angle X-ray diffraction patterns were obtained with a Rigaku MiniFlex II desktop X-ray diffractometer operated at 15 mA and 30 kV (Rigaku Americas Corporation, TX). Samples of starch fiber compositions were exposed to Cu K-alpha radiation (0.15405 nm) and continuously scanned between 4 and 30° 2θ at a scanning rate of 1°/min with a step size of 0.02°. Data were analyzed with Jade™ v.8 software (Material Data Inc., Livermore, Calif.). To calculate the degree of crystallinity, an amorphous halo was subtracted from the overall X-ray diffraction pattern. The overall area was calculated as the area between the linear baseline and data points. The amorphous halo was generated by Jade™ software using the cubic spline fit option. The degree of crystallinity was calculated as the proportion of the crystalline area of the overall area multiplied by 100.

### Example 2

Gelose 80 starch (Penford Food Ingredients Company, Centennial, Colo.) is used as received. Gelose 80 is a corn starch with amylose content of about 80%. Hylon VII, Hylon V, Melojel, and Amioca starches (Corn Products International, Bridgewater, N.J.) are all corn starches with amylose content according to the manufacturer of approximately 70%, 55%, 25% and 0-1%, respectively. Mung bean starch was purified from a mung bean starch powder product from a local Asian market. The mung bean starch powder was dispersed in deionized water and allowed to precipitate. The precipitate was washed with 50% (v/v) ethanol in water for 3 times and finally with pure ethanol and dried. Mung bean starch has an amylose content of about 35%, see Hoover et al., Food Hydrocolloids, 1997, 11:401-408. Ethanol (200 proof) and dimethyl sulfoxide (DMSO) obtained from VWR International (Radnor, Pa.) is used.

The preparation of spinning dope involved dissolving the appropriate amount of starch in an aqueous DMSO solution. The starch dispersion was heated in a boiling water bath with continuous stirring on a magnetic stirrer hotplate for about one hour. The starch dispersion was then allowed to cool to room temperature and deaerated. A 10 mL syringe (Becton, Dickinson and Company, Franklin Lakes, N.J.) with a 20 gauge blunt needle was used as the spinneret.

The wet-electrospinning setup as described in Example 1 and shown in FIG. 1 is used. The fibrous mat deposited in the ethanol coagulation bath was then washed using pure ethanol and dried in a desiccator containing Drierite under vacuum. Wet-electrospinning was conducted at room temperature in this example.

The wet-electrospinnability of each starch dispersion was evaluated while varying three spinning parameters, feed rate, voltage, and spinning distance, within predetermined ranges: feed rates of 0.1, 0.25 and 0.4 mL/h, and spinning distances of 5, 7.5, and 10 cm. At each feed rate and spinning distance combination, the voltage was gradually increased from 0 to 15 kV. The onset and ending voltages of continuous jet formation were recorded. The wet-electrospinnability for starch dispersions was determined by visual and microscopic observation of the fibers formed.

Characterization

Fiber morphology was examined using an Olympus BX41 optical microscope (Hitech Instruments, Edgemont, Pa.) equipped with cross polarizers and a SPOT Insight QE camera (SPOT Diagnostic Instruments, Sterling Heights, Mich.). Image analysis was completed using SPOT analytical and controlling software. Observation of fibers was also performed using a FEI Quanta 200 ESEM (FEI, Hillsboro, Oreg.) in low vacuum mode at an accelerating voltage of 20 keV.

Rheology

Starch dispersions in aqueous DMSO solutions were prepared for rheological characterization. DMSO concentration ranged from 70 to 100% (v/v). For each DMSO concentration, starch concentrations of 0.1 to 30% (w/v) were prepared. Flow curves, i.e. shear viscosity versus shear rate, were generated using cone and plate geometry on a strain-controlled rheometer (ARES, TA Instrument, New Castle, Del.). The cone and plate diameters were 50 mm and the gap was set at 0.043 mm. The cone angle was 0.04 radians. Viscosity data were collect in the shear rate range from 0.1 s⁻¹ to 100 s⁻¹ at 20° C.

Rheological Properties

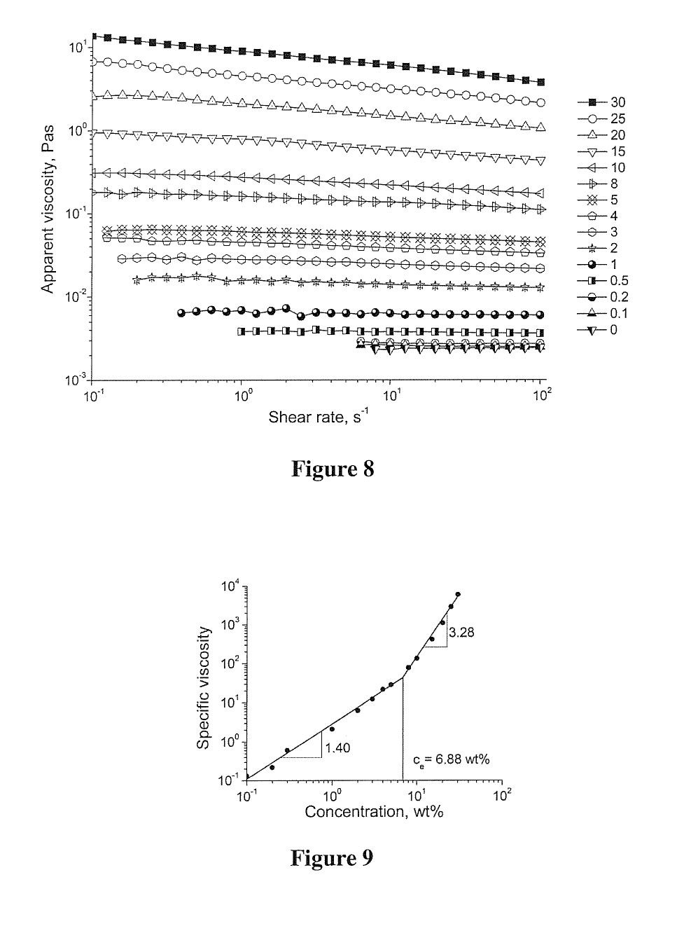

Flow curves of Gelose 80 starch in 100% DMSO as a function of starch concentration (% w/v) at 20° C. are shown in FIG. 8. Unreliable data, i.e. out of the detection limit of the rheometer, were not plotted. Pure DMSO and dispersions of low starch concentrations approached Newtonian behavior, i.e. shear viscosity was independent of shear rate; up to 10% (w/v) of starch, the dispersions did not show significant shear thinning. As starch concentration was increased beyond 10% (w/v) shear thinning became apparent. By fitting the power law model, η=K\dot{γ}ⁿ⁻¹, to the data for 30% (w/v) Gelose 80 starch dispersions, the power law index, n, was calculated to be 0.82, indicating the presence of a weak shear thinning effect; the viscosity decreased less than 1 order of magnitude over three decades of shear rate.

Zero shear viscosities, η₀, were approximated from the flow curves by using the actual or extrapolated values for apparent viscosity at 0.1 s⁻¹, and used to calculate specific viscosity, ηₛₚ=(η₀−η_{z})/ηₛ. In order to determine the critical entanglement concentration, cₑ, specific viscosity data were plotted against starch concentration. The cₑ was thus determined to be 6.88% (w/v) from the intercept of the fitted slopes in the semidulte unentangled and the semidilute entangled regimes. FIG. 9 shows a plot of specific viscosity versus Gelose 80 starch concentration in 100% DMSO. The entanglement concentration and slopes of fitted lines in two regimes are illustrated. In the semidilute unentangled regime, the specific viscosity, ηₛₚ, was proportional to c^{1.40}. In the semidilute entangled regime, ηₛₚ was ˜c^{3.28}.

Flow curves of Gelose 80 starch in 97.5%, 95%, 92.5%, 90%, 85, 80%, 75%, and 70% (v/v) DMSO as a function of starch concentration at 20° C. were obtained. The general trend from low to high starch concentration is similar to starch in pure DMSO. The starch dispersions of intermediate concentrations (3 to 10% w/w) developed complicated flow behavior in DMSO lower than 90%. The shear viscosity increased with shear rate and decreased after a peak viscosity.

Flow curves of Hylon VII starch, Hylon V starch, Mung bean starch, Melojel starch, and Amioca starch in 95% (v/v) DMSO as a function of starch concentration at 20° C. were also obtained.

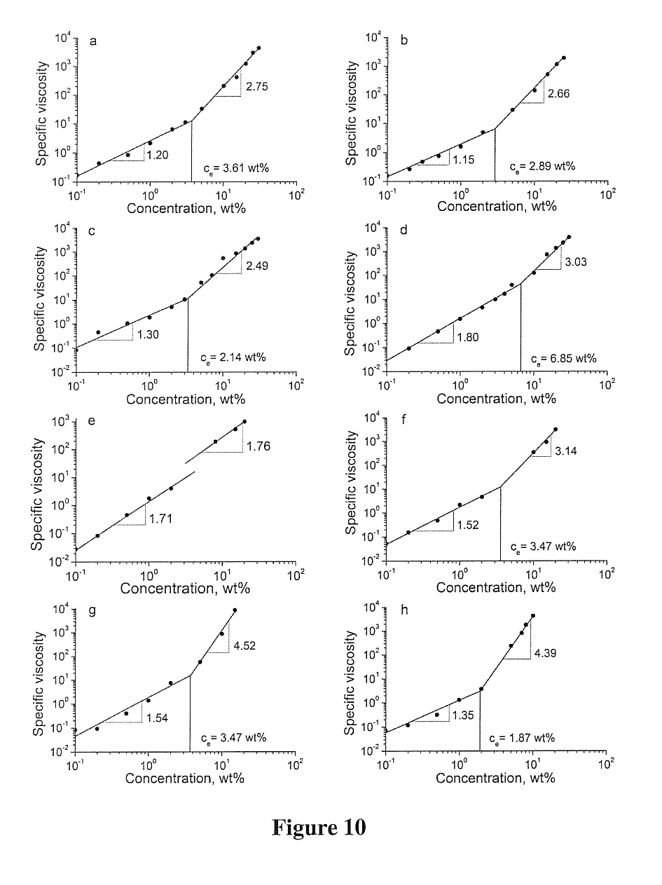

Entanglement concentration values for starch in different DMSO solutions were obtained by plotting specific viscosity versus starch concentration. FIG. 10 shows plots of specific viscosity versus Gelose 80 starch concentration in (a) 97.5%, (b) 95%, (c) 92.5%, (d) 90%, (e) 85%, (f) 80%, (g) 75%, and (h) 70% (v/v) DMSO aqueous solutions. The entanglement concentrations and slopes of fitted lines in two regimes are illustrated. Exponents of the concentration dependence in the unentangled regime ranged from 1.20 to 1.80, indicating weak interaction of individual molecules and absence of significant entanglements. Exponents of the concentration dependence in the entangled regime ranged from 2.66 to 3.03 for DMSO concentration greater than 85%. The dependence becomes stronger for starch in 75% and 70% aqueous DMSO solutions. These DMSO solutions were not able to totally dissolve the starch, which significantly increased the starch dispersion viscosity. This was evidenced by visual observation of the dispersion; starch in 75% and 70% DMSO solutions appeared as an opaque white suspension, in contrast to the transparent or translucent yellowish dispersion of starch in more concentrated DMSO solutions. This transition occurred at about 85% DMSO making measurement of the viscosities at this concentration highly unstable and preventing an accurate determination of cₑ.

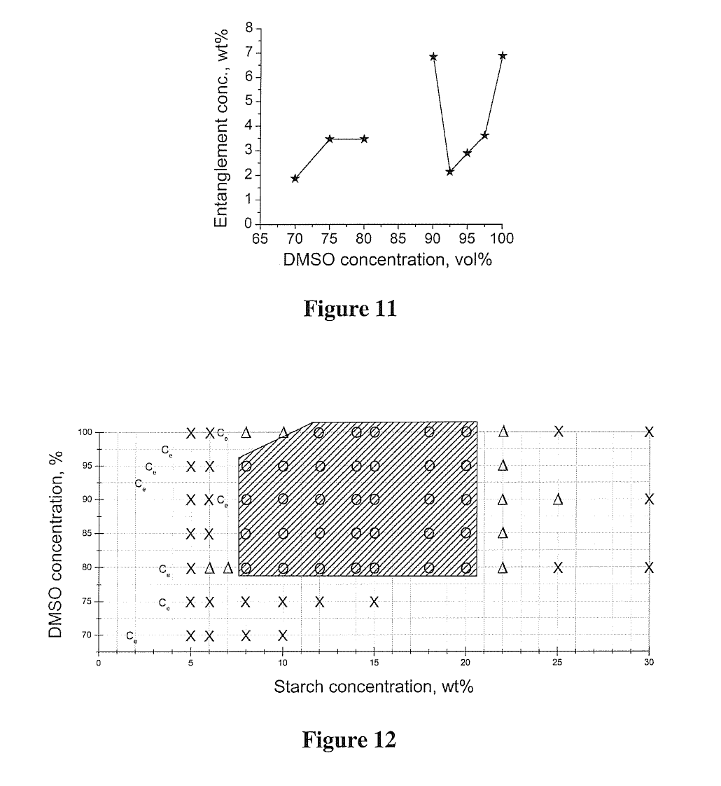

FIG. 11 shows a graph of the entanglement concentrations of Gelose 80 starch as a function of DMSO concentration. In the range of 100% to 90% DMSO where starch can be effectively dissolved, the critical entanglement concentration cₑ reaches a minimum at 2.14% (w/v) in 92.5% DMSO, suggesting that solvation is highest at 92.5% aqueous DMSO. With better solvation extended coils occupy a larger hydrodynamic volume so that the overlap concentration is lower.

Correlation with Electrospinnability

A series of starch dispersions in each DMSO concentration was subject to wet-electrospinning on the apparatus shown in FIG. 1. The fiber forming ability (electrospinnability) was examined in the predetermined process parameter ranges. A spinnability map illustrating regions of spinnability at varying concentrations of DMSO and starch was constructed and is shown in FIG. 12. FIG. 12 shows the results of evaluation of fiber formation abilities from starch dispersions of different starch and DMSO concentration: good fiber formed (circles), poor fiber formed (triangles), and no fiber formed (Xs). The shaded area in FIG. 12 represents the electrospinnable region of the materials used. Entanglement concentrations are also approximately labeled in FIG. 12. Starch dispersions with good fiber forming ability are marked in the shaded area. During the spinning of these dispersions, a continuous and stable jet could be induced and fibers were deposited on the surface of the ethanol bath without accompanying sprayed particles. Optical microscopy and scanning electron microscopy were also employed to evaluate the fiber morphology. Scanning electron micrographs of electrospun pure gelose 80 starch fibers from (a) 8% and (b) 12% (w/v) starch in 100% DMSO, (c) 8% and (d) 10% (w/v) starch in 95% DMSO, (e) 8% and (f) 10% (w/v) starch in 90% DMSO, (g) 8% and (h) 10% (w/v) starch in 85% DMSO, and (i) 8% and (j) 10% (w/v) starch in 80% DMSO were produced.

Good fibers are continuous, uniform, smooth, and defect-free. At lower concentrations, wet-electrospinning was constantly interrupted by electrospraying using parameters outside of the shaded area and producing mixtures of poor and short fibers and particles. Poor fibers are too fragile to be collected from the coagulation bath. Microscopic observation of the poor fibers shows lack of uniformity, defects and presence of debris. Electrospraying also occurred at high concentrations outside the shaded area at low feed rates. In addition, at high feed rates the jet did not develop whipping instability and the process appeared like simple wet-spinning.

The critical concentration for electrospinnability c* may be considered the concentration at which good fibers start to form and c*/c, values can be obtained for Gelose 80 starch in different DMSO concentrations. These values are 1.7, 2.7, 1.2, and 2.3 for Gelose 80 starch in 100%, 95%, 90% and 80% DMSO aqueous solutions, respectively.

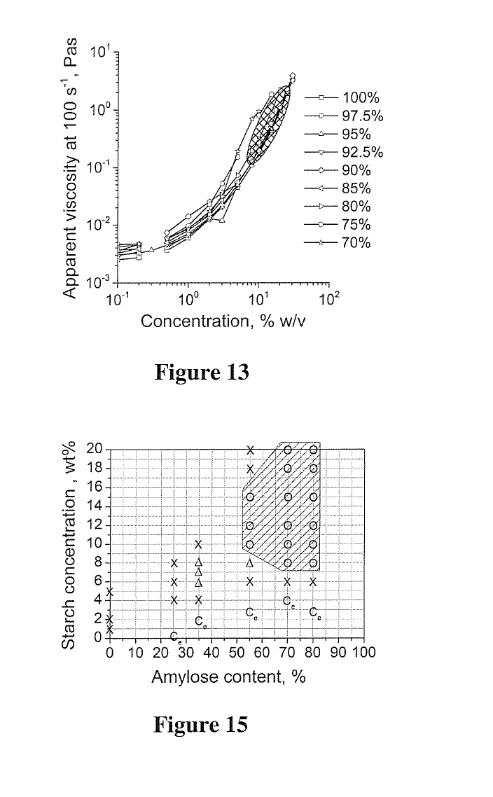

Shear viscosities (at 100 s⁻¹) of the Gelose 80 starch dispersions plotted as a function of starch concentration in different DMSO concentrations are shown in FIG. 13 and the region of spinnability denoted. All wet-electrospinnable dispersions fall into the shade area. From this graph, one can observe that all the electrospinnable dispersions have a shear viscosity clustered in the shade area, i.e. from 0.2 to 2.2 Pa·s. At higher concentrations, where sufficient molecular entanglement has been well established, the high viscosity of the Gelose 80 starch dispersion could be the factor that limits electrospinnability. At lower concentrations in the range from cₑ to c*, where molecular entanglement was also fulfilled, the low viscosity and absence of shear thinning suggested that the entanglement of the starch molecules was insufficient. While the shear viscosity at 100 s⁻¹ has some implication on wet-electrospinnability, it should be noted that the actual shear rate involved in electrospinning must be much higher than 100 s⁻¹. These results show that starch conformation, presence of entanglement and shear viscosity together influence the electrospinnablity of a starch-DMSO-water dispersion.

In this example the wet-electrospinnability was not evaluated under constant process parameters. If the parameters had been set constant, the wet-electrospinnable window would have been smaller than the current shaded area. In the experiment, starch dispersions from the left edge of the shaded area were found to be inappropriate for electrospinning at a low feeding rate, large spinning distance and low voltage. The situation was reversed for concentrated starch dispersions. For example, 8% (w/v) starch dispersion in 80% DMSO was only spinnable at the highest feeding rate and the shortest spinning distance in this example. A continuous jet and fibers began to form when the voltage was increased to 10 kV, but the jet became unstable when the voltage reached 12 kV. In another example, good fibers from 20% (w/v) starch in 100% DMSO were only obtainable at the largest spinning distance and lowest feeding rate. At a spinning distance of 10 cm and voltage of 10 kV, increasing the feed rate from 1 to 2 mL/h resulted in good fibers becoming poor fibers.

These phenomena are related to the rheological properties of the starch dispersions. From the flow curves, highly concentrated starch dispersions (e.g. 20% (w/v)) develop shear thinning at lower shear rates than moderately concentrated starch dispersions (e.g. 8-10%, w/v). Hence, higher feeding rate and higher voltage/spinning distance (i.e. higher shear rate) are required to develop sufficient molecular alignment and shear thinning for moderately concentrated starch dispersions. On the contrary, highly concentrated starch dispersions do not require such high shear rate for orienting the starch molecules in the flow. The wet-spinning parameters, including starch concentration, thus interact in unexpected ways.

Effect of Amylose/Amylopectin Ratios

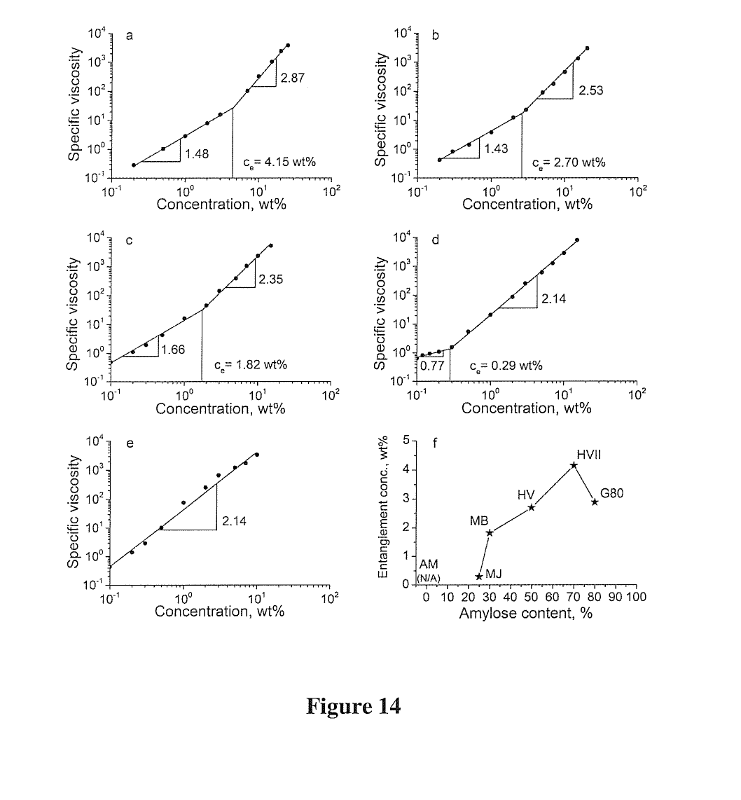

Starches of different amylose/amylopectin ratios in 95% aqueous DMSO were characterized by rheological measurements. By plotting specific viscosities versus starch concentrations, the critical entanglement concentration cₑ values were obtained. FIGS. 14 a-e show plots of specific viscosity versus starch concentration for (a) Hylon VII (HVII), (b) Hylon V (HV), (c) Mung bean starch (MB), (d) Melojel starch (MJ), and (e) Amioca waxy maize starch (AM) in 95% (v/v) DMSO aqueous solution, and FIG. 14f shows a plot of entanglement concentration as a function of amylose content in the starches. The exponents of the concentration dependence in the semidilute unentangled and entangled regimes are all in good agreement with that of Gelose 80 starch. Weak entanglements were formed in the semidilute entangled regime, which became weaker as amylopectin content increases. Amylose is the major contributor to extended coils and their entanglements, though larger, amylopectin behaves as a hard ellipsoid. The entanglement concentration cₑ is the highest in Hylon VII starch (4.15%, w/v) and decreases to 0.29% (w/v) for Mejogel starch, probably due to the high molecular weight of amylopectin. A cₑ value was not obtainable within the concentration range of this experiment for waxy maize starch that has 0-1% amylose content. The exponents of concentration dependence in the entangled regime were found to be consecutively decreasing as amylose content decreased. In high amylose starches, where amylose entanglements dominate, the molecules interpenetrate into one another and can be well entangled. As the amylose content decreases, the amylose molecules contribute less and the amylopectin components dominate. These bulky objectives cannot entangle very much due to steric hindrance.

The wet-electrospinnability of starches of different amylose content were evaluated. FIG. 15 shows results of evaluation of wet-electrospinnability from starch dispersions of different starches in 95% DMSO: good fiber formed (circles), poor fiber formed (triangles), and no fiber formed (Xs). The starches have varying amylose content: Amioca (0-1%), Melogel (25%), mung bean starch (30%), Hylon V (55%), and Hylon VII (70%). The shaded area in FIG. 15 represents the electrospinnable region. Entanglement concentrations are also approximately labeled in FIG. 15.

Wet-electrospinning of Hylon VII starch in 95% DMSO was successful in the concentration range of 8 to 20% (w/v). This range becomes smaller and smaller as amylose content in the starch decreases. The wet-electrospinnable range for Hylon V shrinks to between 10 and 15% (w/v). Poor mung bean starch fibers were only obtainable from a concentration around 7% (w/v). Melogel and Amioca starches were not wet-electrospinnable at any concentration in 95% DMSO. Electron micrographs of electrospun fibers produced show this trend. Scanning electron micrographs of wet-electrospun pure starch fibers from (a) 18% (w/v) Hylon V, (b) 8% (w/v) Hylon VII, (c) 8% (w/v) Hylon V, and (d) 7% (w/v) Mung bean starch in 95% (v/v) DMSO aqueous solutions were produced.

The c*/cₑ values were determined to be 3.8, 3.7, and 1.9 for mung bean starch, Hylon V and Hylon VII, respectively. The Hylon V and mung bean starch need a higher concentration to be wet-electrospun, probably due to their low content of amylose, though molecular weight and other characteristics may also be of importance in the establishment of chain entanglement.

In this example, in order to obtain well-formed fibers, the concentration of starch had to be 1.2 to 2.7 times the entanglement concentration cₑ depending on the DMSO concentration. In addition to the establishment of molecular entanglements, molecular conformation and shear viscosity are also of importance in determining the wet-electrospinnability.

### Example 3

### Materials

Hylon VII starch was supplied by Corn Products International, Bridgewater, N.J. and used as received. Hylon VII is a corn starch with amylose content of about 70%. Dimethyl sulfoxide (DMSO) was obtained from VWR International (Radnor, Pa.).

### Wet-Electro Spinning

The preparation of spinning dope involved dissolving the appropriate amount of starch in 95% (v/v) aqueous DMSO solution. The starch dispersion was heated in a boiling water bath with continuous stirring on a magnetic stirrer hotplate for about one hour. The starch dispersion was then allowed to cool to room temperature and deaerated. A 10 mL syringe (Becton, Dickinson and Company, Franklin Lakes, N.J.) with a 20 gauge blunt needle was used as the spinneret.

The wet-electrospinning setup comprised a higher voltage generator (ES40P, Gamma High Voltage Research, Inc., Ormond Beach, Fla.), a syringe pump (81620, Hamilton Company, Reno, Nev.), and a grounded metal mesh immersed in pure ethanol as described in Example 1 and shown in FIG. 1. This wet-electrospinning configuration can also be referred to as “electro-wet-spinning”. The fibrous mat deposited in the ethanol coagulation bath was then washed using pure ethanol and dried in a desiccator containing Drierite under vacuum.

Quadratic Model

In order to establish a quantitative relationship between fiber diameter and spinning parameters, a fractional experimental design for a constrained region using a quadratic model was created by ECHIP, ECHIP, Inc., Hockessin, Del., see Wheeler, et al., 1993, EChips user's guide version 6.0 for Windows. Hoskessin, Del.: EChip, Inc.

Four variables were included in the model: starch concentration (10 to 15%, w/v), voltage (6 to 10 kV), spinning distance (5 to 8 cm), and feed rate (2 to 4 ml/h). The constraints were specified by a “point-percentage” method provided by ECHIP. Within the experiment range, two extreme combinations were identified as non-operational conditions according to previous experiments, i.e. starch concentration at 10% (w/v), voltage at 6 kV, spinning distance at 8 cm and feed rate at 2 ml/h; and starch concentration at 15, voltage at 10, spinning distance at 5 and feed rate at 4. Two pieces of experimental region were cut off by two imaginary planes perpendicular to the vector from the center of the experimental region to the non-operational points and located at 10% of the distance from the center. The design contained 28 experiments, 25 unique combinations, and 3 replications, Table 2. Five unique checkpoints were then used to validate the initial model and added to create a new model.

Fiber Morphology

Observation of fibers was performed using a FEI Quanta 200 environmental scanning electron microscope (ESEM, FEI, Hillsboro, Oreg.) in low vacuum mode at an accelerating voltage of 20 KeV. Fiber diameter was measured from the ESEM images. Five images were used for each fiber sample and at least 100 different segments were randomly measured to obtain an average diameter.

Fiber samples from each experimental run were observed using electron microscopy, and evaluated according to their spinning behavior and fiber morphology, Table 2.

Design of experiments and response results.

| | | Feed rate | Spinning distance | | Starch concentration | | | Fiber |
|---|---|---|---|---|---|---|---|---|
| Run^{a} | Trial^{b} | (ml/h) | (on) | Voltage (kV) | (% w/v) | Diameter (μm) | SD^{c} | evaluation^{d} |
| 1 | 12 | 3.2 | 5 | 8.4 | 10 | 10.38 | 2.21 | ++ |
| 2 | 20 | 2 | 6.5 | 10 | 12.5 | 9.56 | 3.57 | ++ |
| 3 | 4 | 4 | 7.4 | 10 | 10 | 47.4 | 2.54 | + |
| 4 | 19 | 3 | 8 | 8 | 15 | 16.34 | 5.30 | + |
| 5 | 7 | 3.6 | 8 | 10 | 10 | 3.64 | 1.69 | − |
| 6 | 3 | 4 | 7.4 | 6 | 15 | 12.00 | 3.96 | ++ |
| 7 | 5 | 4 | 8 | 7.6 | 12 | 8.33 | 3.33 | + |
| 8 | 15 | 2 | 5 | 10 | 11 | 12.84 | 3.02 | + |
| 9 | 13 | 2 | 5 | 6.8 | 15 | 21.18 | 4.97 | − |
| 10 | 18 | 4 | 8 | 8.4 | 13 | 8.84 | 2.40 | ++ |
| 11 | 3 | 4 | 7.4 | 6 | 15 | 12.16 | 3.56 | ++ |
| 12 | 2 | 4 | 5 | 6 | 10 | 7.81 | 3.86 | ++ |
| 13 | 1 | 2 | 5 | 6 | 15 | 21.79 | 7.92 | − |
| 14 | 9 | 2.8 | 5 | 6 | 12 | 9.15 | 3.03 | ++ |
| 15 | 14 | 4 | 5.6 | 6 | 10 | 11.18 | 4.11 | + |
| 16 | 22 | 4 | 8 | 10 | 10 | 4.12 | 2.72 | − |
| 17 | 6 | 2 | 8 | 10 | 14 | 11.11 | 2.42 | ++ |
| 18 | 2 | 4 | 5 | 6 | 10 | 8.06 | 3.52 | ++ |
| 19 | 10 | 3 | 6.5 | 8 | 12.5 | 4.70 | 2.00 | ++ |
| 20 | 23 | 2 | 7.4 | 10 | 15 | 13.24 | 5.68 | − |
| 21 | 25 | 3.2 | 8 | 10 | 13 | 8.99 | 2.01 | ++ |
| 22 | 8 | 3.8 | 8 | 6 | 14.5 | 4.43 | 1.41 | ++ |
| 23 | 21 | 4 | 5 | 6 | 11 | 10.93 | 3.11 | ++ |
| 24 | 24 | 2.8 | 6.8 | 6 | 15 | 12.14 | 4.06 | ++ |
| 25 | 17 | 2 | 6.8 | 7.6 | 15 | 22.35 | 6.37 | − |
| 26 | 16 | 2.8 | 6.8 | 10 | 10 | 3.35 | 1.43 | ++ |
| 27 | 11 | 2 | 5 | 9.2 | 10 | 10.39 | 1.96 | ++ |
| 28 | 1 | 2 | 5 | 6 | 15 | 20.56 | 8.41 | − |
| Validation runs^{e} | | | | | | | | |
| 29 | 26 | 3 | 6 | 7 | 10 | 7.40 | 2.13 | ++ |
| 30 | 27 | 4 | 5.5 | 8 | 10.5 | 5.66 | 1.67 | ++ |
| 31 | 28 | 3 | 6.5 | 7 | 13.5 | 9.26 | 2.16 | ++ |
| 32 | 29 | 3.5 | 6 | 10 | 11.5 | 10.95 | 1.75 | ++ |
| 33 | 30 | 2.8 | 7.5 | 7.5 | 14.5 | 9.64 | 2.00 | ++ |

^{a}Run signifies the order in which the experiments were conducted.
^{b}Each trial with a different number indicates a unique set of experimental conditions.
^{c}Standard deviation of the fiber diameters.
^{d}Fibers were evaluated and classified into good fibers (++), fair fibers (+), and poor fibers (−).
^{e}Runs of unique experimental conditions chosed for initial model validation.

Table 2 shows that 16 out of 28 runs produced good fibers, i.e. those that are continuous and have few droplets. Of 28 fiber samples 5 were evaluated as fair. These fibers are largely continuous but may have some droplets or thick fibers. The final 7 runs produced poor fibers. Some of these runs, e.g. 1, 13, 17, and 23, resulted in thick fibers. These runs resulting in poor fibers used the highest starch concentrations and relatively high voltage/distance ratios, At these wet-electrospinning conditions, the jet did not develop whipping instability and the process appeared like simple wet-spinning. The other two runs, i.e., 7 and 22, produced too many droplets by electrospraying, instead of electrospinning. These two runs used the lowest starch concentration and the greatest spinning distance. The fiber morphology can probably be influenced by both surface tension and viscosity. The surface tension tends to reduce surface area per unit mass and thus favors the formation of droplets or particles, while viscoelastic forces promote the formation of fibers, At low material concentrations, surface tension may have a dominating impact over viscoelastic force. However, at high concentration, high viscosity brims difficulty in the extension of the jet and thus results in thick fibers. With only two constraints for a 4-dimensional experimental design, these combinations were included in the constrained region, because a balance between well-defined operational range and enough space to have distant points has to be considered for the prediction power of the model.

When all of the experimental runs were used to construct a model for the effect of spinning parameters on fiber diameter, starch concentration was the only significant parameter (r²=0.88, p-value=0.0007). However, when all of the poor fiber data were eliminated, a model with 12 significant terms (r²=0.94, p-value=0.0143) was obtained. The poor fibers were obtained by mechanisms other than true electrospinning and, thus, should not be included in the model construction and refinement for electro spinning.

Model Construction

Fiber diameter data of the good and fair fibers were used for regression analysis. Five additional unique runs were used as checkpoints for model validation. The root mean square of the residuals between checkpoints and predictions was calculated to be 2.08, smaller than the residual standard deviation for non-checkpoints, i.e. 2.09. Therefore, the model can be considered a good one and the predictions reliable. Insignificant terms were then removed to refine the model.

Table 3 provides the coefficients of the final statistical model and the significance of each term. All the terms involving feed rate were insignificant in determining the fiber diameter and thus not included in the final model.

Coefficients determined for response model.

| | Coefficient | |
|---|---|---|
| Parameter | for diameter^{a} | p |
| Constant(β₀) | 7.09 | |
| FeedRate(β₁) | NI^{b} | |
| Distance(β₂) | −3.76 | 0.0009 |
| Voltage(β₃) | 1.43 | 0.0023 |
| StarchConc(β₄) | 3.31 | 0.0002 |
| FeedRate × Distance(β₅) | NI | |
| FeedRate × Voltage(β₆) | NI | |
| FeedRate × StarchConc(β₇) | NI | |
| Distance × Voltage(β₈) | −1.13 | 0.0294 |
| Distance × StarchConc(β₉) | −2.25 | 0.0245 |
| Voltage × StarchConc(β₁₀) | 1.22 | 0.0057 |
| FeedRate²(β₁₁) | NI | |
| Distance²(β₁₂) | 2.38 | 0.0125 |
| Voltage²(β₁₃) | NI | |
| StarchConc²(β₁₄) | 1.32 | 0.0041 |
| r^{2c} | 0.683 | |
| p^{d} | 0.0041 | |

^{a}Diameter = β₀ + β₁(FeedRate − 3) + β₂(Distance − 6.5) + β₃(Voltage − 8) + β₄(StarchConc − 12.5) + β₅(FeedRate − 3) × (Distance − 6.5) + β₆(FeedRate − 3) × (Voltage − 8) + β₇(FeedRate − 3) × (StarchConc − 12.5) + β₈(Distance − 6.5) × (Voltage − 8) + β₉(Distance − 6.5) (StarchConc − 12.5) + β₁₀(Voltage − 8) × (StarchConc − 12.5) + β₁₁(FeedRate − 3)² + β₁₂(Distance − 6.5)² + β₁₃(Voltage − 8)² + β₁₄(StarchConc − 12.5)².
^{b}NI, not included. Inclusion of this coefficient in the model did not improve the fit.
^{c}Regression coefficient of the model to predict the response variable.
^{d}p value for the model to predict the response variable.

As shown in the footnote, the model used centering values by subtracting the average of the high and low limits of the variables. With centering removed, the fitted second-order equation for average fiber diameter is given by: Diameter=165.924-2.465×Distance−6.475×Voltage−24.825×StarchCone−1.13×Distance×Voltage−2.25×Distance×StarchCone+1.22×Voltage×StarchCone+2.38×Distance²+1.32×StarchCone²

According to the model, the smallest mean fiber diameter obtainable, without an added process like mechanical drawing, is 3.98 μm at a starch concentration of 10% (w/v), feed rate of 2.8 ml/h, voltage of 10 kV, and distance of 6.8 cm, which is identical the conditions of ran 16. The largest mean fiber diameter is outside the experimental design region.

Wet-Electrospinning Parameters and their Interactions

For starch concentration from 10 to 15% (w/v), contour plots of the predicted mean fiber diameter were produced. Each contour visualizes the effects of voltage and spinning distance at the corresponding starch concentration. Increasing starch concentration increases the lower limit of the fiber diameter.

For all starch concentrations, the fiber diameter is more responsive to spinning distance than to voltage. The interaction of voltage and spinning distance can also be observed according to the nonlinear contour lines. The interaction effect follows a similar trend regardless of starch concentration. The condition for smallest fiber diameter shifted from the high voltage, intermediate distance region to the low voltage, long distance region as starch concentration increased. Rheological studies described herein show that low starch concentration requires higher shear rate brought about by higher voltage to distance ratio for aligning the starch molecules in the jet, whereas highly concentrated starch dispersion does not need such high shear rate. Both increasing and decreasing the ratio of voltage to distance from this condition tended to increase the fiber diameter. The ratio of voltage to distance can also be defined as electric field strength as described in Sukigara, et al., 2004 Polymer, 45(11), 3701-3708.

Lowering the electric field strength will decrease the electric stress on the starch dispersion and the efficiency in drawing the fiber. However, increasing the electric field strength from the center region accelerates the jet so quickly that whipping instability cannot be well developed. This will shorten the spiral loop path of the jet, where the jet is extensively elongated. Further increase of the electric field strength will result in a process like simple wet-spinning, as described for runs 1, 13, 17, and 23.

The contour plots generated indicate that the fiber diameter is very responsive to starch concentration. At short wet-electrospinning distances (5 and 6.5 cm), the effect of voltage is largely negligible, as can be seen from the slope of the curves. At long spinning distance, the effect of voltage is also not apparent for intermediate starch concentrations. But voltage has more effect on fiber diameter at low and high starch concentrations.

The contour plots generated for constant voltages show that at higher starch concentrations greater wet-electrospinning distances were needed in order to produce fibers with equivalent diameters. The predicted condition for the smallest fiber diameter is located near spinning distance of about 6.5 to 7 cm.

### Example 4

High amylose maize starch (Hylon VII) from Ingredion Incorporated, Bridgewater, N.J., was used as received for procedures described in this example. Dimethyl sulfoxide (DMSO) was obtained from VWR International (Radnor, Pa.). Guest materials cetyl trimethylammonium bromide (CTAB) from J. T. Baker, Philipsburg, N.J., palmitic acid (PA) from Eastman Kodak Company, Rochester, N.Y., and ascorbyl palmitate (AP) from SigmaAldrich, Inc, St. Louis, Mo. were used. Lipid-free Hylon VII starch was produced by dispersing the starch in 90% DMSO aqueous solution followed by ethanol precipitation. Wet-electrospinning of lipid-free starch with and without AP was conducted as a control to exclude native lipids as the sole guest in inclusion complex formation.

Wide Angle X-Ray Diffraction

Wide angle X-ray diffraction patterns were obtained with a Rigaku MiniFlex II desktop X-ray diffractometer (Rigaku Americas Corporation, TX). Samples were exposed to Cu Kα radiation (0.154 nm) and continuously scanned between 2θ=4 and 30° at a scanning rate of 1°/min with a step size of 0.02°. A current of 15 mA and voltage of 30 kV were used. Data were analyzed with Jade™ v.8 software (Material Data Inc., Livermore, Calif.). The area of the amorphous halo generated by Jade™ software using the cubic spline fit option was subtracted from the total X-ray diffraction area to obtain the crystalline fraction. The degree of crystallinity was then calculated as the crystalline fraction over the total area multiplied by 100.

Thermal Analysis

Approximately 5 mg of sample was weighed into a 60 μL stainless steel differential scanning calorimeter (DSC) pan (Perkin-Elmer Instruments, Norwalk, Conn.) and water added to obtain a 10% (w/v) dispersion. Pans were hermetically sealed. Samples were equilibrated to 20° C., and then heated to 170° C. at 2° C./min in a Thermal Advantage Q100 DSC (TA Instruments, New Castle, Del.). The DSC was calibrated with indium, with an empty sample pan used as the reference. Data was analyzed using the TA Universal Analysis software (Universal Analysis 2000 v.4.2E, TA Instruments-Waters LLC, New Castle, Del.).

Fourier Transformed Infrared (FTIR) Spectroscopy

For fiber samples, Fourier transform infrared spectroscopy (FTIR) was performed on a Bruker IFS 66/S FT-IR Spectrometer (Bruker Optics Ltd., Billerica, Mass.) equipped with a Hyperion 3000 FT-IR Microscope. Spectra of thin sections of fiber mat were obtained by an accumulation of 400 scans in transmission mode from 500 cm⁻¹ to 4000 cm⁻¹ with a resolution of 6 cm⁻¹. For powder samples, FTIR was performed on a Bruker v70 Spectrometer (Bruker Optics Inc., Billerica, Mass.) equipped with an MVP-Pro™ Star Diamond attenuated total reflectance (ATR) accessory (Hayrick Scientific Products, Inc., Pleasantville, N.Y.). The spectra were scanned at room temperature over the wave number range of 400 to 4000 cm⁻¹, with an accumulation of 100 scans and a resolution of 6 cm⁻¹.

Wet-Electro Spinning

The wet-electrospinning setup used in this study contained a high voltage generator (ES40P, Gamma High Voltage Research, Inc., Ormond Beach, Fla.), a syringe pump (81620, Hamilton Company, Reno, Nev.), and a grounded metal mesh immersed in an ethanol/water mixture. A 10 ml syringe (Becton, Dickinson and Company, Franklin Lakes, N.J.) with a 20 gauge blunt needle was used to extrude the starch dispersion for electrospinning. Wet-electrospinning was conducted at room temperature in this example. Feed rate was set at 4 ml/h, spinning distance at 7.5 cm and voltage at 7.5 kV. The fibrous mat deposited in the coagulation bath was then washed using ethanol and dried in a desiccator containing Drierite under vacuum. Some starch fibers were subject to a post-spinning heat treatment; a sample of starch fiber mat was placed in a 50% (v/v) aqueous ethanol solution and heated at 65° C. for one hour, after which the sample was washed with ethanol and dried as above.

Dope mixing for starch-guest inclusion complex formation in starch fibers

In this method the guest material is mixed with the starch dispersion prior to wet-electrospinning. In this example, 15% (w/v) of starch was dissolved in a 95% (v/v) DMSO aqueous solution. The starch dispersion was heated in a boiling water bath with continuous stirring on a magnetic stirrer hotplate for about one hour. Heat-stable guest material was mixed into the starch dispersion during heating, while heat-labile guest material was mixed after the homogenous dispersion was cooled to room temperature.

Inclusion complex formation in wet-electrospun fibers: dope mixing. Three different guest compounds were mixed into the starch dispersion before wet-electrospinning. The addition of guest compounds may affect the wet-electrospinnability of the starch dispersions. The 15% (w/v) starch dispersion with more than 5% PA was not wet-electrospinnable because of increase in viscosity, while the addition of CTAB made the jet unstable probably due to change in conductivity and surface tension of the dispersion. Hence, PA and AP were added up to 5% of starch weight for electrospinning. Two coagulation bath compositions, i.e. 100% and 75% ethanol were evaluated in terms of inclusion complex formation.

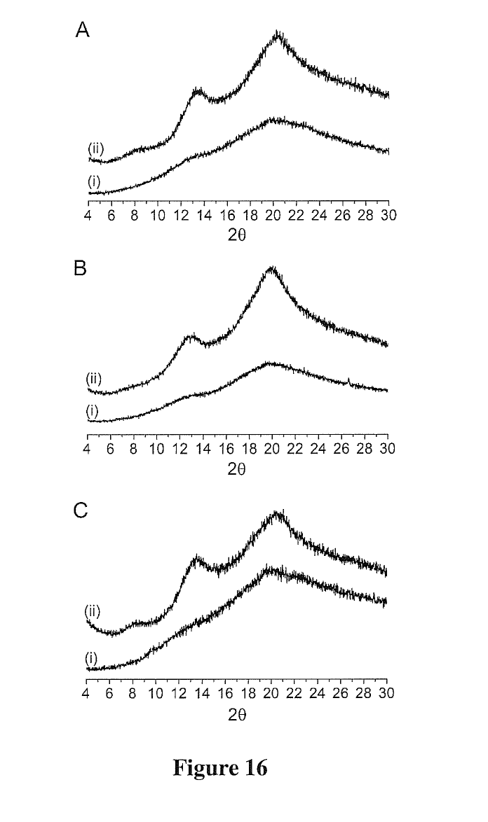

The X-ray diffraction patterns of starch-PA and starch-AP fibers deposited into both 100% and 75% (v/v) ethanol remained similar to those without guest compounds added. FIG. 16 shows X-ray diffraction patterns of (A) starch without guest, (B) starch-PA, and (C) starch-AP fibers from coagulation baths containing (i) 100% and (ii) 75% (v/v) ethanol, respectively. The fibers from 75% ethanol coagulation bath all showed V-type X-ray diffraction patterns. The anhydrous V-type patterns suggested that guest compounds, if included, were entrapped intra-helically instead of inter-helically, since the unavailability of inter-helical space for the molecules. The crystallinity was estimated to be 30% and 26% for starch-PA and starch-AP fibers, respectively. The fibers from 100% ethanol coagulation bath showed a very weak V-pattern, indicating less extent of inclusion complex formation or the so-called “type I non-crystalline” inclusion complexes.

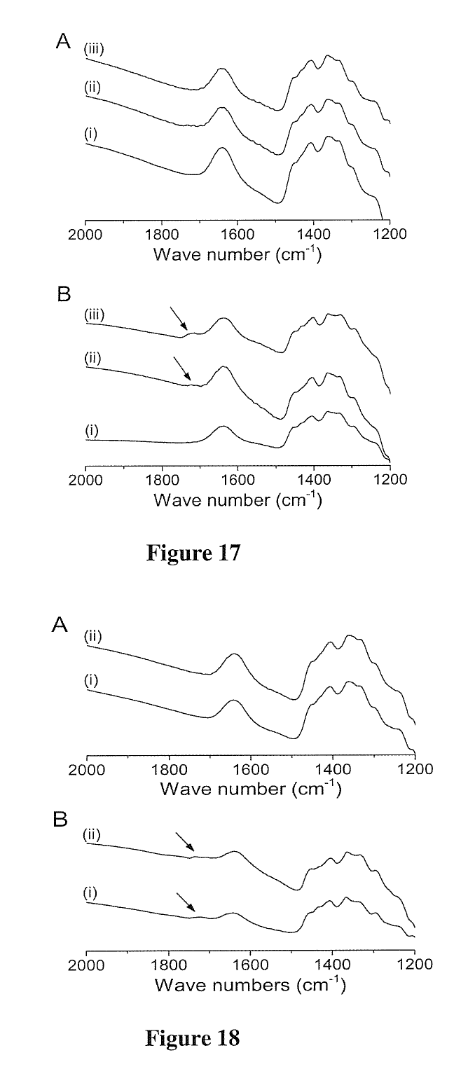

FTIR was used to determine the presence of guest compounds in the starch fibers. FIG. 17 shows FTIR spectra of starch-PA fibers from coagulation baths containing (A) 100% (v/v) and (B) 75% (v/v) ethanol, with different PA levels in spinning dope: (i) 1%, (ii) 2.5%, and (iii) 5% (w/w) of starch. FIG. 18 shows FTIR spectra of starch-AP fibers from coagulation baths containing (A) 100% (v/v) and (B) 75% (v/v) ethanol, with different AP levels in spinning dope: (i) 1%, and (ii) 5% (w/w) of starch. Arrows indicate the band for AP. Arrows indicate the band for PA. Starch-PA and starch-AP fibers from 100% ethanol did not show any characteristic peaks for PA and AP, respectively. Above 2.5% of PA, starch-PA fibers from 75% ethanol started to show a peak at around 1722 cm⁻¹, which is attributed to the carbonyl group in PA. The carbonyl bands in raw PA and AP powders were positioned at about 1696 and 1730 cm⁻¹, respectively. This characteristic peak for the carbonyl group was found in starch-AP fibers with 1% of AP mixed into the spinning dope. The peaks shifted slightly to a higher wave number at 1735 cm⁻¹ in 5% AP added starch fibers. The FTIR results suggested that by using 100% ethanol as the coagulation bath, few compounds were included into the starch helices and those uncomplexed helices were loosely and irregularly packed. 75% ethanol facilitated the inclusion complex formation and improved the regularity of helical arrangement.

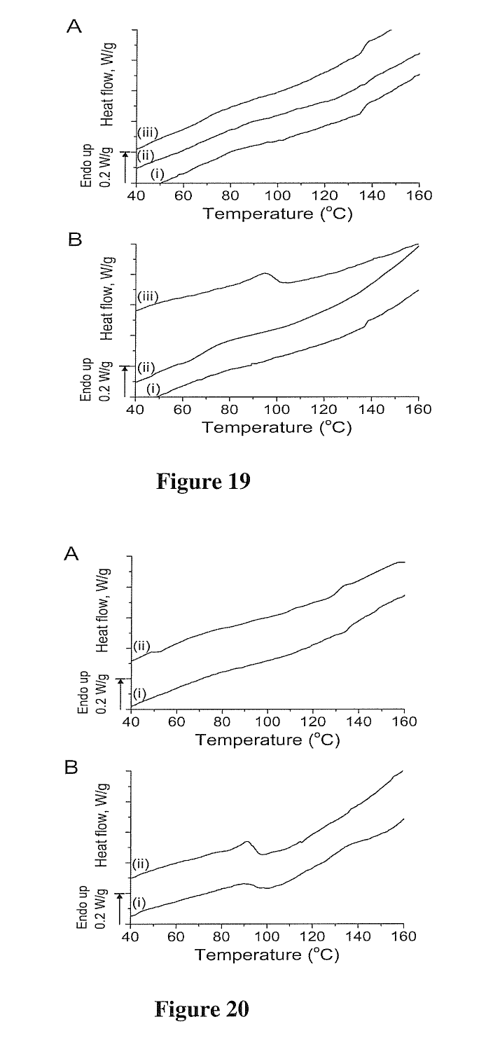

FIG. 19 shows DSC curves of starch-PA fibers from coagulation baths containing (A) 100% (v/v) and (B) 75% (v/v) ethanol, with different PA levels in spinning dope: (i) 1%, (ii) 2.5%, and (iii) 5% (w/w) of starch. FIG. 20 shows DSC curves of starch-AP fibers from coagulation baths containing (A) 100% (v/v) and (B) 75% (v/v) ethanol, with different AP levels in spinning dope: (i) 1%, and (ii) 5% (w/w) of starch. Thermograms of starch-PA and starch-AP fibers from 100% ethanol showed a broad and flat endotherm between 60 to 100° C., indicating limited complexation took place. This agrees with the weak V-pattern for the fibers from 100% ethanol; a very small amount of PA, AP and native lipids in starch could have been included in starch molecules in the fibers. Approximately 1% (w/w) monoacyl lipids, e.g. palmitic, stearic, and linoleic acid, exist in native high amylose maize starch. These lipids are potentially able to form inclusion complexes with starch. The presence of various lipids resulted in different structures of inclusion complexes, e.g. length of helices, and thus different thermal stabilities of the inclusion complexes. The thermograms also show an endotherm with a peak temperature about 140° C., which can be attributed to the dissociation of retrograded amylose.

A broad and flat endotherm from 50 to 90° C. was observed during heating of starch-PA fibers from 75% ethanol at a PA level of 1%. The endotherm shifted to higher temperatures (65 to 100° C.), as PA level increased to 2.5%. The broad and flat endotherm was again caused by different inclusion complex structures with native lipids and PA that was added at low levels. When 5% PA was added, a single narrow endotherm at around 94.5° C. was observed, which can be attributed to the dissociation of inclusion complexes mainly between starch and PA. In starch-AP fibers from 75% ethanol, a single narrow endotherm at around 91° C. was obtained at both AP levels. Higher AP level resulted in a higher dissociation enthalpy, 3.3 J/g at 5% AP versus 2.0 J/g at 1% AP. The lower enthalpy indicates a larger portion of uncomplexed starch, which otherwise retrograded as can be evidenced by an endotherm from 130 to 145° C.

As a comparator method, 500 mg of starch was dissolved in 10 mL of 95% (v/v) DMSO aqueous solution in a boiling water bath with constant stirring for at least one hour. Then 1 ml of ascorbyl palmitate (50 mg) solution in 95% DMSO preheated at 90° C. was mixed with the amylose/starch solution at 90° C. The mixed solution was held for 15 minutes at 90° C., and then 25 mL of distilled water preheated at 90° C. was rapidly added to the solution with vigorous stirring. The sample solution was incubated for 15 min at 90° C. The samples were then allowed to cool for at least 24 hours. Inclusion complexes were recovered by centrifugation, washed three times with 50/50 ethanol/water solution, and then washed with 100% ethanol. The resulting pellet was transferred to an aluminum dish with little amount of 100% ethanol, allowed to dry at room temperature in a desiccator. Dried samples were pulverized into fine powders for further analysis.

Compared with the inclusion complexes formed by the traditional DMSO method, the peak temperature was the same, but the enthalpy of dissociation was much lower in the fiber samples. The Hylon VII starch-PA inclusion complex made by DMSO method had a peak temperature at 94.5° C. and enthalpy of 14.3 J/g.

Bath mixing for Starch-guest inclusion complex formation in starch fibers

In this method the guest material is mixed into the coagulation bath and fibers are wet-electrospun into the coagulation bath. In this example, a 100 ml coagulation bath was used and the guest material was dissolved in the coagulation bath to achieve a concentration from 0.1% to 0.5% (w/v) for AP and from 0.1% to 2% (w/v) for CTAB. About 1-2 ml of 15% (w/v) starch dispersion was then wet-electrospun into the coagulation bath.

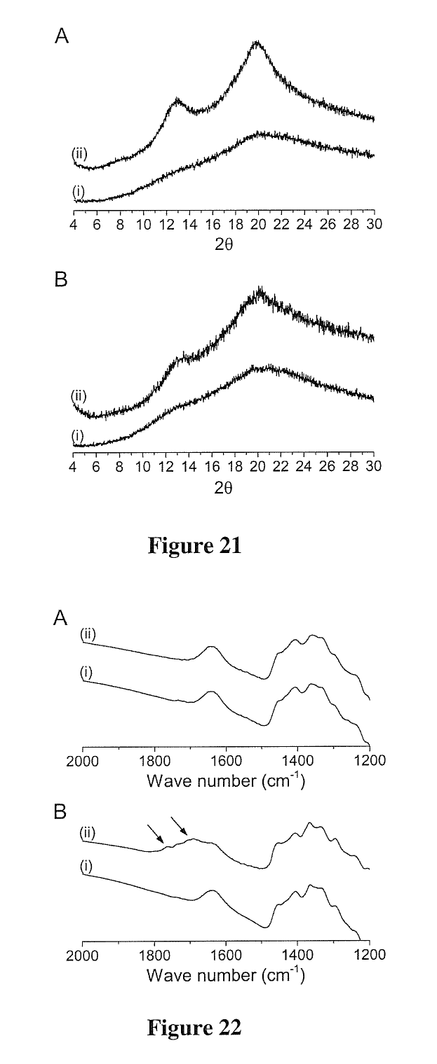

Inclusion complex formation in electrospun fibers: bath mixing. AP and CTAB were mixed into the coagulation baths prior to wet-electrospinning of starch dispersions. FIG. 21 shows X-ray diffraction patterns of starch fibers from coagulation baths containing (A) 0.5% (w/v) AP and (B) 2% (w/v) CTAB in (i) 100% and (ii) 75% (v/v) ethanol, respectively. The X-ray patterns of the starch fibers were identical to those from coagulation baths without addition of guest compounds. The V-type X-ray diffraction patterns suggested the formation of inclusion complexes in the starch fibers.

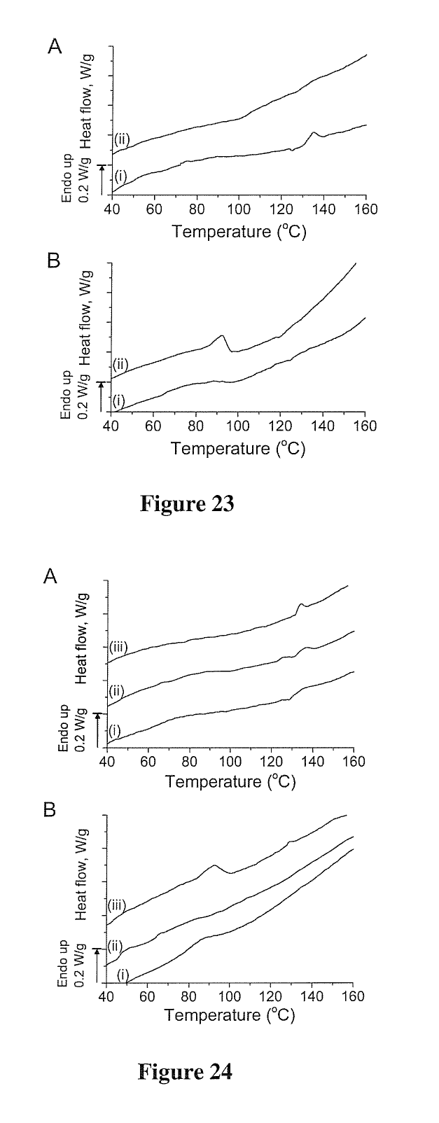

AP was found to be present in the starch fibers from 75% ethanol according to the FTIR spectra. FIG. 22 shows FTIR spectra of starch fibers from coagulation baths containing (A) 100% (v/v) and (B) 75% (v/v) ethanol and different AP concentrations: (i) 0.1%, and (ii) 0.5% (v/v) of the coagulation bath. A characteristic carbonyl band was positioned at about 1733 to 1740 cm⁻¹ for starch-AP fibers from both 100% and 75% ethanol with 0.1% AP, indicating a small amount of fatty acids or their esters, e.g. AP, were included into starch helices. The heterogeneity of the inclusion complex structure could also be evidenced from the broad and flat endotherm between 50 to 100° C. for these fiber samples, FIG. 23. FIG. 23 shows DSC curves of starch fibers from coagulation baths containing (A) 100% (v/v) and (B) 75% (v/v) ethanol and different AP concentrations: (i) 0.1%, and (ii) 0.5% (w/v) of the coagulation bath. When 0.5% AP was mixed into 75% ethanol, the carbonyl band of the starch-AP fiber shifted further to an even higher wave number (1764 cm⁻¹) than that by dope mixing method. This shift could be induced by more starch-AP inclusion complex formation, which is also evidenced by a higher dissociation enthalpy about 5.8 J/g from the thermogram, seen in FIG. 23. The peak endotherm temperature was the same (91° C.) as that of starch-AP dissociation by the dope mixing method. The difference in guest material addition methods did not affect the helical length of inclusion complexes.

FIG. 24 shows DSC curves of starch fibers from coagulation baths containing (A) 100% (v/v) and (B) 75% (v/v) ethanol and different CTAB concentrations: (i) 0.1%, (ii) 1%, and (iii) 2% (w/v) of the coagulation bath. A single narrow endotherm with a peak temperature at 92° C. was obtained in the thermogram of starch fiber recovered from 2% CTAB in 75% ethanol. The starch-CTAB inclusion complexes demonstrated the same thermal stability as the starch-AP inclusion complexes. It was expected that the two types of inclusion complex have the same length, because both CTAB and AP have C16 hydrocarbon chain.

By the bath mixing method, inclusion complex formation in fibers requires a higher amount of CTAB, i.e. 2%, than the amount of AP, i.e. 0.5%, in the 75% ethanol coagulation bath.

The Effect of Native Lipids

Lipid-free starch was used for electrospinning to determine if the presence of native lipids is a necessity for inclusion complex formation in the starch fibers.

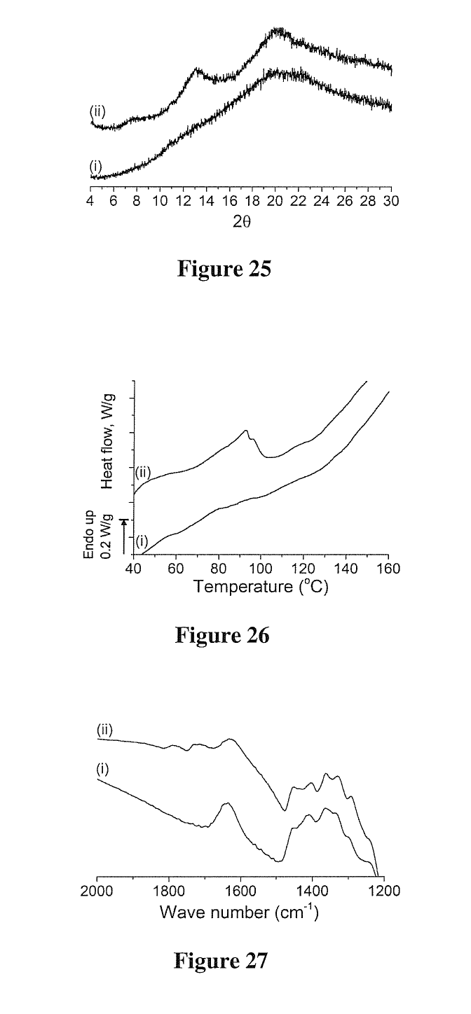

The electrospun lipid-free starch fibers recovered from 75% ethanol bath showed V-type diffraction patterns. FIG. 25 shows X-ray diffraction patterns of lipid-free starch fibers recovered from coagulation bath containing (i) 100% and (ii) 75% (v/v) ethanol. Without guest molecules, starch would precipitate out of solution by simple retrogradation in conventional inclusion complex preparation methods, which would result in a B-type pattern. The current finding suggested that fast collapse of starch from ethanol resulted in single helices and the empty inclusion complex formation was able to take place without the presence of guest molecules. The lipid-free starch fibers showed a very low and broad endotherm that is similar to regular starch-guest fibers recovered from 100% ethanol. FIG. 26 shows DSC curves of (i) lipid-free starch fibers and (ii) lipid-free starch-AP (5%, w/w) fibers from 75% (v/v) ethanol. Without guest lipids, this suggested that the low and broad endotherm could be associated with “non-crystalline” amylose complex without guests. Lipid-free starch-AP fibers were prepared by electrospinning using the dope mixing method. An endotherm peaked at around 93° C. was observed, which is not significantly affected in the absence of native lipids. The presence of AP in the starch fibers was also evidenced by the carbonyl bands (1730 and 1778 cm⁻¹) on IR spectrum, see FIG. 27. FIG. 27 shows FTIR spectra of lipid-free starch-AP (5%, w/w) fibers recovered from (i) 100% and (ii) 75% (v/v) ethanol. In conclusion, there were no differences in inclusion complex formation between raw starch and lipid-free starch.

Starch-Guest Inclusion Complex Formation in Wet-Electrosprayed Starch Powders

AP was mixed into 10% (w/v) starch in 95% DMSO dispersions, and heated in a boiling water bath with continuous stirring on a magnetic stirrer hotplate for about one hour as described for the dope mixing method for starch-guest inclusion complex formation in starch fibers.

A lower voltage, outside the feasibility range for electrospinning, is used for wet-electrospraying to produce starch powders according to aspects of methods of the present invention. In this example, starch dispersions including guest material were subjected to a voltage at 8 kV at a spinning distance of 6 cm. The electrosprayed powders in the coagulation bath were recovered by centrifugation. The precipitate was further washed with pure ethanol and dried under ambient conditions.

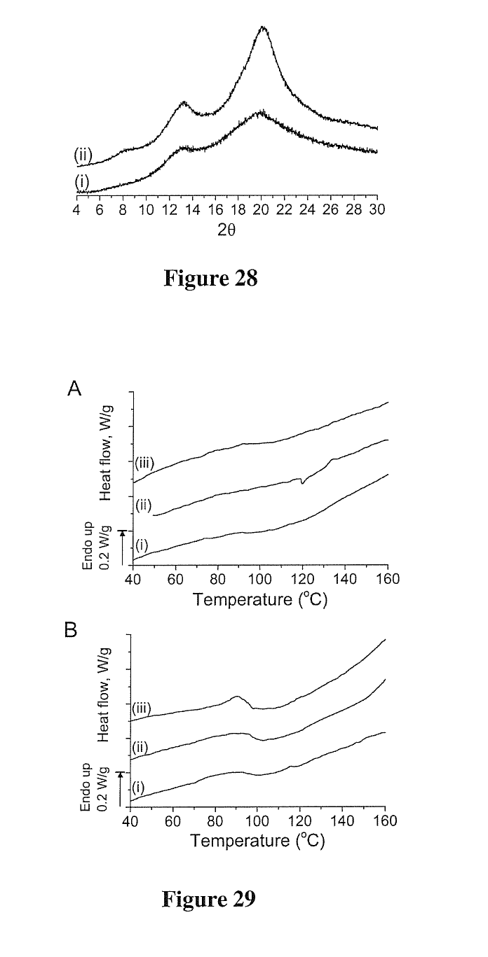

The wet-electrosprayed powders showed V-type X-ray patterns, indicating the formation of inclusion complexes. FIG. 28 shows X-ray diffraction patterns of electrosprayed powders from coagulation baths containing (i) 100% and (ii) 75% (v/v) ethanol, respectively. AP loading level in starch dispersion was 5% (w/v) of starch weight. The crystallinity was estimated to be 25% and 38% for the powders from 100% and 75% ethanol, respectively. The higher crystallinity than starch fibers suggested more crystalline phase formation in the wet-electrosprayed powders, probably because the electrical stress was lower and thus it was easier for the starch molecules to retract from their extended state in the flow.

Thermograms of the wet-electrosprayed powders from 100% ethanol showed a broad and flat endotherm between 50 and 100° C., which had the same origin as the endotherm in the fibers. FIG. 29 shows DSC curves of electrosprayed powders from coagulation baths containing (A) 100% and (B) 75% (v/v) ethanol, respectively. AP levels in starch dispersions were (i) 1%, (ii) 5%, and (iii) 10% (w/w) of starch weight. A narrower endotherm between 70 and 100° C. was obtained for electrosprayed powders from 75% ethanol with AP levels equal to or less than 5%. Different guest compounds including AP might have been included into the starch helices. The broad endotherm might be resulted from different lengths of helices or less efficiency in including AP molecules. When AP was loaded as high as 10%, the dissociation endotherm was mainly contributed by starch-AP inclusion complexes. The peak temperature was 91° C., same as that for fibers containing starch-AP inclusion complexes. The enthalpy of starch-AP dissociation was estimated to be 3.0 J/g, indicating less efficiency in formation of inclusion complexes, even at such high guest concentration. Although it was easier for the starch molecules to retract and form helices, it might be difficult for the AP molecules to enter the less extended starch molecules.

### Example 5

Spinning dope is prepared by dissolving starch and pullulan in any ratio in the range of 100:1-1:100 w/w starch:pullulan in a 70% or greater DMSO aqueous solution. The starch+pullulan dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 6

Spinning dope is prepared by dissolving starch, alpha-cyclodextrin and/or beta-cyclodextrin in any ratio in the range of 100:1-1:1 w/w starch:cyclodextrin in a 70% or greater DMSO aqueous solution where the total solid is 18% w/v of the total solution or dispersion. The starch+cyclodextrin dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 7

Spinning dope is prepared by dissolving starch and agarose in any ratio in the range of 100:1-1:1 w/w starch:agarose in a 70% or greater DMSO aqueous solution where the total solid is 15% w/v of the total solution or dispersion. The starch+agarose dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 8

Spinning dope is prepared by dissolving starch and starch acetate in any ratio in the range of 100:1-1:1 w/w starch:starch acetate in a 70% or greater DMSO aqueous solution. The starch+starch acetate dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 9

Spinning dope is prepared by dissolving starch and cellulose in any ratio in the range of 100:1-1:1 w/w starch:cellulose in a 70% or greater DMSO aqueous solution. The starch+cellulose dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 10

Spinning dope is prepared by dissolving starch and cellulose in any ratio in the range of 100:1-10:1 w/w starch:methylcellulose in a 70% or greater DMSO aqueous solution. The starch+methylcellulose dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 11

Spinning dope is prepared by dissolving starch and cellulose in any ratio in the range of 100:1-10:1 w/w starch:hydroxypropyl methyl cellulose in a 70% or greater DMSO aqueous solution. The starch+hydroxypropyl methyl cellulose dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 12

Spinning dope is prepared by dissolving starch and poly(ethylene oxide) in a ratio of 1000:1-50:1 w/w starch:poly(ethylene oxide) in a 70% or greater DMSO aqueous solution, total solid is 15% w/v of the total solution or dispersion. The starch+poly(ethylene oxide) dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 13

Spinning dope is prepared by mixing starch, a plasticizer and clay particles in a ratio of 3:1:0.15 w/w/w starch:plasticizer:clay in a 70% or greater DMSO aqueous solution, total solid is 20.75% w/v of the total solution or dispersion. The starch/plasticizer/clay dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 14

Spinning dope is prepared by mixing starch, pullulan and a plasticizer in a ratio of 2:1:1 w/w/w starch:pullulan:plasticizer in a 70% or greater DMSO aqueous solution, total solid is 20% w/v of the total solution or dispersion. The starch/pullulan/plasticizer dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 15

Spinning dope is prepared by mixing starch, pullulan and a plasticizer in a ratio of 1:1:1 w/w/w starch/pullulan/plasticizer in a 70% or greater DMSO aqueous solution, total solid is 22.5% w/v of the total solution or dispersion. The starch/pullulan/plasticizer dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 16

Spinning dope is prepared by mixing starch, starch acetate and clay particles in a ratio of 2:1:0.1 w/w/w starch:starch acetate:clay in a 70% or greater DMSO aqueous solution, total solid is 15.5% w/v of the total solution or dispersion. The starch/starch acetate/clay dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 17

Spinning dope is prepared by mixing starch, pullulan, a plasticizer and clay particles in a ratio of 1:1:1:0.05 w/w/w/w starch/pullulan/plasticizer/clay in a 70% or greater DMSO aqueous solution, total solid is 22.875% w/v of the total solution or dispersion. The starch/pullulan/plasticizer/clay dispersion is heated in a boiling water bath with continuous stirring for about one hour, and allowed to cool to room temperature. The resulting spinning dope is subjected to wet-electrospinning or wet-electrospraying to produce fibers or particles as described herein.

### Example 18

Spinning dope is prepared by mixing starch, a first plasticizer and a second plasticizer in a ratio of 2:1:1 w/w/w starch/first plasticizer/second plasticizer in a 70% or greater DMSO aqueous solution, total solid is 30% w/v of the total solution or dispersion. The starch/first plasticizer/second plasticizer dispersion is heated in a boiling water bath with continuous stirring for about one hour, and allowed to cool to room temperature. The resulting spinning dope is subjected to wet-electrospinning or wet-electrospraying to produce fibers or particles as described herein.

Any patents or publications mentioned in this specification are incorporated herein by reference to the same extent as if each individual publication is specifically and individually indicated to be incorporated by reference.

The compositions and methods described herein are presently representative of preferred embodiments, exemplary, and not intended as limitations on the scope of the invention. Changes therein and other uses will occur to those skilled in the art. Such changes and other uses can be made without departing from the scope of the invention as set forth in the claims.

1. A method for making a starch fiber composition or starch particle composition, comprising:
providing a spinning dope comprising a solution or dispersion of starch in an aqueous or non-aqueous solvent or dispersant, where the starch is present at a concentration above the critical entanglement concentration where starch fibers are to be produced or where the starch is present at a concentration from 1% to 40% weight % where starch particles are to be produced, with the proviso that the aqueous or non-aqueous solvent or dispersant does not consist only of water;
heating the spinning dope to a temperature above the melting temperature or dissolution temperature of starch in the solvent or dispersant to produce a heated spinning dope;
wet-electrospinning or wet-electrospraying the heated spinning dope to produce starch fibers or starch particles, respectively; and
contacting the starch fibers or starch particles with a coagulation bath fluid, forming a starch fiber composition or starch particle composition.

2. The method of claim 1, further comprising: washing the starch fiber composition or starch particle composition in a wash fluid to at least partially remove the solvent or dispersant.

3. The method of claim 1, further comprising heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol.

4. The method of claim 1, further comprising drying the starch fiber composition or starch particle composition.

5. The method of claim 1, further comprising mixing a filler with the solution or dispersion of starch.

6. The method of claim 5, wherein the filler comprises nanoparticles.

7. The method of claim 5, wherein the filler is substantially insoluble in the aqueous or non-aqueous solvent or dispersant.

8. The method of claim 7, wherein the filler is clay nanoparticles.

9. The method of claim 7, wherein the filler is cellulose nanoparticles.

10. The method of claim 1, further comprising exposing the starch fiber composition or starch particle composition to a cross-linking agent to produce a cross-linked starch fiber composition or cross-linked starch particle composition.

11. The method of claim 1, wherein the aqueous or non-aqueous solvent or dispersant is selected from: DMSO, an aqueous solution of DMSO, aqueous solution of N-methyl morpholine N-oxide (NMMO), N,N-dimethylacetamide with 3% LiCl, dimethylformamide (DMF), and an aqueous solution of DMF.

12. The method of claim 1, wherein the coagulation bath fluid is an alcohol or an alcohol/water mixture having an alcohol/water ratio in the range of 20/80-99.9/0.1.

13. The method of claim 12, wherein the alcohol is selected from the group consisting of: methanol, ethanol, 1-propanol, isopropyl alcohol, butyl alcohol, amyl alcohol, pentanol, hexanol, heptanol; and a mixture of any two or more thereof.

14. The method of claim 1, wherein heating the starch fiber composition or starch particle composition in an aqueous or non-aqueous solution of alcohol at a temperature below the melting temperature or dissolution temperature of the starch fiber composition or starch particle composition in the aqueous or non-aqueous solution of alcohol comprises heating the starch fiber composition or starch particle composition in an aqueous or non-aqueous solution of alcohol wherein the aqueous or non-aqueous solution of alcohol is an alcohol or an alcohol/water mixture having an alcohol/water ratio in the range of 20/80-100/0, and wherein the alcohol is selected from the group consisting of: methanol, ethanol, 1-propanol, isopropyl alcohol, butyl alcohol, amyl alcohol, pentanol, hexanol, heptanol; and a mixture of any two or more thereof.

15. The method of claim 1, further comprising mixing an auxiliary material with the solution or dispersion of starch.

16. The method of claim 1, further comprising mixing an auxiliary material with the coagulation bath fluid.

17. The method of claim 15, wherein the auxiliary material is selected from the group consisting of: a bioactive compound, a drug, a pharmaceutical composition; a food ingredient, a flavoring agent, a dye, an enzyme; an agricultural agent, a pesticide, an industrial agent, a deodorant, a corrosion inhibitor, a fluorescent dye, a catalyst; and combination of any two or more thereof.

18. The method of claim 1, further comprising mixing a non-starch polymer, a plasticizer or both with the solution or dispersion of starch.

19. A starch fiber composition or starch particle composition, comprising at least 50, 60, 70, 80, 90, 95, 99 or greater wt % starch and a nanoparticulate filler.

20. The starch fiber composition or starch particle composition of claim 19, wherein the starch is cross-linked.

21. The starch fiber composition or starch particle composition of claim 19, wherein the nanoparticulate filler comprises clay nanoparticles.

22. The starch fiber composition or starch particle composition of claim 19, wherein the nanoparticulate filler comprises cellulose nanoparticles.

23. The starch fiber composition or starch particle composition of claim 19, wherein the nanoparticulate filler comprises carbon nanoparticles.

24. The starch fiber composition or starch particle composition of claim 19, wherein the starch fibers have a diameter in the range of 1-999 nanometers.

25. The starch fiber composition or starch particle composition of claim 19, wherein the starch fibers have a diameter in the range of 1-999 micrometers.

26. The starch fiber composition or starch particle composition of claim 19, further comprising an auxiliary material.

27. The starch fiber composition or starch particle composition of claim 26, wherein the auxiliary material is selected from the group consisting of: a bioactive compound, drug, pharmaceutical, food ingredient, flavor, dye, enzyme, agricultural agent, pesticide, industrial agent, deodorant, corrosion inhibitor, fluorescent dye and catalyst.

28-29. (canceled)
